(19) United States
(12) Patent Application Publication
(10) Pub. No.: US 2012/0110511 A1
(43) Pub. Date: May 3, 2012

(54) INTEGRATING USER INTERFACES

(76) Inventor: Damian Howard, Winchester, MA (US)

(21) Appl. No.: 13/309,744

(22) Filed: Dec. 2, 2011

Related U.S. Application Data
(63) Continuation of application No. 11/935,374, filed on Nov. 5, 2007.
Application No. 11/935,374 is a continuation-in-part of application No. 11/750,822, filed on May 18, 2007, now abandoned.
Application No. 11/750,822 is a continuation-in-part of application No. 11/612,003, filed on Dec. 18, 2006, now abandoned.

(51) Int. Cl. G06F 3/048

(52) U.S. Cl. 715/835; 715/853

(57) ABSTRACT

An external interface to a portable device that has its own native interface is provided. The native interface of the portable device presents options of a first level of a hierarchy, and upon selection of a first one of the options, replaces the display of options with a new display of a first set of options from a second level of the hierarchy, the first set of options from the second level corresponding to the first option from the first level. The external interface displays at least a subset of the options of the first level of the hierarchy, the subset including the first option and at least one second option, indicates in the display that the first option is selected, and simultaneously displays the first set of options from the second level of the hierarchy

### CROSS-REFERENCE TO RELATED APPLICATIONS

This patent application related to U.S. patent application Ser. No. 11/835,374 (filed Nov. 5, 2007, and titled Integrating User Interfaces), U.S. patent application Ser. No. 11/750,822 (filed May 18, 2007, and titled Integrating Navigation Systems), and U.S. patent application Ser. No. 11/612,003 (filed Dec. 18, 2006, and titled Integrating Navigation Systems). This application claims priority to U.S. patent applications Nos. 11/835,374, 11/750,822, and 11/612,003. U.S. patent applications Nos. 11/835,374, 11/612,003, and 11/750,822 are hereby incorporated by reference into this patent application as if set forth herein in full.

### BACKGROUND

This patent application relates to integrating graphical user interfaces.

In-vehicle entertainment systems and portable navigation systems sometimes include graphical displays, touch-screens, physical user-interface controls, and interactive or one-way voice interfaces. They may also be equipped with telecommunication interfaces including terrestrial or satellite radio, Bluetooth®, WiFi®, or WiMax®, GPS, and cellular voice and data technologies. Entertainment systems integrated into vehicles may have access to vehicle data, including speed and acceleration, navigation, and collision event data. Navigation systems may include databases of maps and travel information and software for computing driving directions. Navigation systems and entertainment systems may be integrated or may be separate components.

### SUMMARY

In general, in some aspects, elements of a first graphical user interface having a first format are integrated into a second graphical user interface having a second format to produce a combined graphical user interface that provides access to elements of the first graphical user interface using the second format. The method further comprises controlling a navigation device associated with the first user interface and a vehicle media device associated with the second user interface through the combined graphical user interface. Implementations may also include one or more of the following features, either alone or in combination.

The navigation device may be a portable navigation system. The combined graphical user interface may be displayed on the vehicle media device or on the portable navigation system. The first graphical user interface may comprise at least one icon and the at least one icon may be incorporated into the combined graphical user interface. The first graphical user interface may comprise at least one function and the at least one function may be incorporated into the combined graphical user interface. The combined graphical user interface may incorporate navigation data and/or vehicle information that are transmitted from the navigation device. The combined graphical user interface may comprise display characteristics associated with the navigation device.

The combined graphical user interface may be displayed on the vehicle media device using pre-stored bitmap data residing on the vehicle media device. The combined graphical user interface may be displayed on the vehicle media device using bitmap data transmitted from the navigation device.

This patent application also described mapping first control features of the navigation device to second control features of the vehicle media device, where the second format is a native format of the vehicle media device, and using the second control features to control a graphical user interface that is displayed on the vehicle media device. The graphical user interface comprises first user interface elements of the navigation device and second user interface elements of the vehicle media device. The first control features may comprise elements of a human-machine interface for the navigation device and the second control features may comprise elements of a human-machine interface for the vehicle media device. The method may also include one or more of the following features, either alone or in combination.

At least one of the second control features may comprise a soft button on the graphical user interface. At least one of the second control features may comprise a concentric knob, which includes an outer knob and an inner knob. The outer knob and the inner knob are for controlling different functions via the graphical user interface.

The second control feature may comprise displaying a route view, a map view, or a driving view. Data for those views may be received at the vehicle media device from the portable navigation system.

In general, in some aspects, elements of a first graphical user interface for a portable navigation system are integrated into a second graphical user interface for a vehicle media device to produce a combined graphical user interface. The method further comprises controlling the vehicle media device and the portable navigation system through the combined graphical user interface. The method may also include one or more of the following features, either alone or in combination.

The elements of a third graphical user interface of a second device may be integrated into the second graphical user interface to form a second combined graphical user interface. The third graphical user interface may be for a second portable navigation system. The vehicle media device may be capable of controlling the third device and the vehicle media device through the second combined graphical user interface.

In general, in some aspects, an integrated system may include an integrated user interface that controls both a portable navigation system and a vehicle media device. In the integrated system, the vehicle media device may comprise a microphone, the portable navigation system may comprise voice recognition software, and the integrated system may be capable of transmitting voice data from the microphone to the voice recognition software. The integrated system may also include one or more of the following features, either alone or in combination.

The portable navigation system may be capable of interpreting the voice data as commands and sending the commands to the vehicle media device. The portable navigation system may be capable of interpreting the voice data as commands and processing the commands on the navigation device.

The portable navigation system may comprise a microphone and the vehicle media device may comprise voice recognition software. The integrated system may be capable of transmitting voice data from the microphone to the voice recognition software. The vehicle media device may be capable of interpreting the voice data as commands and sending the commands to the portable navigation system. The vehicle media device may be capable of interpreting the voice data as commands and processing the commands on the vehicle media device.

In general, in some aspects, current vehicle data generated by circuitry of a vehicle is received. The data is processed to produce output navigational information using functions of a personal navigation device that are otherwise used to process internally-derived navigational data that are generated by navigational circuitry in the personal navigation device. Implementations may also include one or more of the following features, either alone or in combination.

The current vehicle data may comprise data from at least one sensor of the vehicle. The current vehicle data may comprise data about the vehicle's location, the data generated from wireless signals and received from a remote source. The current vehicle data may include the last-known location of the vehicle. The current vehicle data may include data collected by one or more of gyroscopes, accelerometers, or speedometers. Using functions of the personal navigation device may include initializing a location-determining process using the last-known location of the vehicle. The current vehicle data may also include information characterizing motion of the vehicle, and using functions of the personal navigation device may include updating a location of the device based on the last-known location of the vehicle and the information characterizing motion of the vehicle.

The navigation functions of the personal navigation device may be used to process the current vehicle data upon an interruption of the personal navigation device's ability to generate the navigational data. The interruption may occur due to an interruption in communications from a remote source of geographic location information. The output navigational information may enable a component of the vehicle having a user interface to display information about the location of the vehicle.

In general, in some aspects, a portable navigation device includes a communications interface for receiving current vehicle data generated by circuitry of a vehicle, circuitry for internally deriving navigational data, and a processor configured to process the current vehicle data received over the communications interface and produce output navigational information using navigation functions that are otherwise used to process the internally-derived navigational data. The portable navigation device may also be configured to provide navigational services based at least in part on the last known location data prior to a determination of the vehicle location from the internally-derived navigational data. A vehicle media device includes a first communication interface for receiving current vehicle data characterizing a location or motion of a vehicle from at least one subsystem of the vehicle, a second communication interface for providing data to a portable second device, and a processor configured to transmit the current vehicle data received from the first communication interface to the second device through the second communication interface. The vehicle media device may also include a receiver for receiving broadcast traffic information, or it may receive traffic information on the first communication interface, and the processor may be configured to transmit the received traffic information to the second device through the second communication interface.

The vehicle media device may be capable of receiving traffic data from a broadcasted signal. The integrated system may be capable of transferring the traffic data to the portable navigation system for use in automatic route calculation.

The vehicle media device may be capable of notifying the navigation system that a collision has occurred. The portable navigation system may be capable of sending an emergency number and a verbal notification to the vehicle media device for making an emergency call. The emergency call may be made hands-free.

The vehicle media device may be configured with a backup camera. The integrated system may be capable of transmitting a backup camera signal to the portable navigation system for display.

The vehicle media device may be configured to receive Global Positioning System (GPS) signals. The vehicle media device may be configured to use the GPS signals to calculate latitude or longitude data. The integrated system may be capable of passing the latitude or longitude data to the portable navigation system.

The vehicle media device may comprise a proximity sensor, which is capable of detecting the proximity of a user's hand to a predetermined location, and of generating an input to the vehicle media device. The integrated system may cause the portable navigation system to generate a response based on the input from the proximity sensor. The response generated by the portable navigation system may be presented on the integrated user interface as a “zooming” icon.

The integrated system may identify the type of the portable navigation system when the portable navigation system is connected to the vehicle media device and use stored icons associated with the type of the portable navigation system.

Implementations may include one or more of the following features. The current vehicle data includes data generated from wireless signals about the vehicle's location and received from a remote source. The current vehicle data about the vehicle's location has a relatively higher level of accuracy than the device navigational data. The current vehicle data includes location information generated by devices on the vehicle. The current vehicle data includes information characterizing motion of the vehicle. The current vehicle data includes data related to operation of the vehicle.

In general, in one aspect, a display location at which information may be displayed to an occupant of a vehicle is associated with a media head unit of the vehicle, and a display is generated at the display location based at least in part on navigational data or output navigational information provided by a personal navigation device.

Implementations may include one or more of the following features. The display location includes a place on the media head unit at which the personal navigation device can be mounted in an orientation that enables an occupant of the vehicle to view a display screen and manipulate controls of the personal navigation device. The display location includes a region of a display of the media head unit. The personal navigation device is separate from the media head unit. The display is generated based in part on navigational data or output navigational information provided by navigational circuitry of the vehicle. The display is generated based in part on data or information unrelated to navigation.

In general, in one aspect, a display is generated at a display location associated with a media head unit of a vehicle based in part on data provided by a personal navigation device separate from the media head unit, and in part on data generated by the media head unit.

Implementations may include one or more of the following features. The data provided by the personal navigation device includes a video image of a map. The data provided by the personal navigation device includes information describing a map. The data provided by the personal navigation device includes information usable by the media head unit to draw a map or display navigation directions based on images stored in a memory of the media head unit. The data generated by the media head unit includes information about a status of a media playback component. The data generated by the media head unit includes information about a two-way wireless communication. The data provided by the personal navigation device comprises information usable by the media head unit to display navigation status based on exchanged data.

In general, in one aspect, user interface commands and navigational data are communicated between a personal navigation device and a media head unit of a vehicle, the user interface commands and navigational data being associated with a device user interface of the device, and a vehicle navigation user interface at the media head unit that displays navigational information and receives user input to control the display of the navigational information on the media head unit, the vehicle navigation user interface being coordinated with the user interface commands and navigational data associated with the device user interface.

In general, in one aspect, a common communication interface between a media head unit of a vehicle and any one of several different brands of personal navigation device carries user interface command information, audio-related signals for navigational prompts, image-related signals for navigational displays, point of interest data, database search commands, and navigational-related data identifying current locations of the vehicle in a common format, and each of the different brands of personal navigation device internally use proprietary formats for at least some of the user interface command information, audio-related signals for navigational prompts, image-related signals for navigational displays, point of interest data, and navigational-related data identifying current locations of the vehicle.

In general, in one aspect, a personal navigation device includes navigational circuitry to generate device navigational data, an input for vehicle data, and a processor configured to process the device navigational data to perform navigational functions and output navigational information. The processor is also configured to process the vehicle data to perform the navigational functions and output the navigational information.

Implementations may include one or more of the following features. The input for vehicle data is configured to receive data generated from wireless signals about the vehicle's location received from a remote source. The input for vehicle data is configured to receive information generated by devices on the vehicle. The input for vehicle data is configured to receive information characterizing motion of the vehicle. The input for vehicle data is configured to receive data related to operation of the vehicle.

In general, in one aspect, a personal navigation device includes a processor for generating a video display of navigational information, an output for providing the video display to a separate device.

In general, in one aspect, a communications interface communicates user interface commands and navigational data associated with a device user interface of a personal navigation device between the personal navigation device and a media head unit. The media head unit has a vehicle navigation user interface including a display of navigational information and an input for receiving user input for control of the display. The vehicle navigation user interface is coordinated with the user interface commands and navigational data associated with the device user interface.

A media head unit of a vehicle receives data from a personal navigation device representing a user interface of the personal navigation device, generates a display for a user interface of the media head unit based on the received data, receives input commands through the user interface of the media head unit, and transmits the user interface commands to the personal navigation device.

The instructions may cause the media head unit to generate the display by combining graphical elements representing the user interface of the personal navigation device with graphical elements representing a status of components of the media head unit.

A personal navigation device having a user interface generates data representing a user interface of the device, transmits the data to a media head unit of a vehicle, receives input commands from the media head unit, and applies the input commands to the user interface of the device as if the commands were received through the user interface of the device.

A personal navigation device having a user interface receives vehicle data from circuitry of a vehicle and processes the vehicle data to produce output navigational information.

Implementations may include one or more of the following features. The instructions cause the device to process the vehicle data to identify a speed of the vehicle. The instructions cause the device to process the vehicle data to identify a direction of the vehicle. The instructions cause the device to process the vehicle data to identify a location of the vehicle. The instructions cause the device to process the vehicle data to identify a location of the vehicle based on a previously-known location of the vehicle and a speed and direction of the vehicle since a time when the previously known location was determined.

In general, in one aspect, personal navigation device includes an interface capable of receiving navigation input data from a media device; a processor structured to generate a visual element indicating a current location from the navigation input data; a frame buffer to store the visual element; and a storage device in which software is stored that when executed by the processor causes the processor to repeatedly check the visual element in the frame buffer to determine if the visual element has been updated since a previous instance of checking the visual element, and compress the visual element and transmit the visual element to the media device if the visual element has not been updated between two instances of checking the visual element.

In general, in one aspect, a method includes receiving navigation input data from a media device, generating a visual element indicating a current location from the navigation input data, storing the visual element in a storage device of a personal navigation device, repeatedly checking the visual element in the storage device to determine if the visual element has been updated between two instances of checking the visual element, and compressing the visual element and transmitting the visual element to the media device if the visual element has not been updated between two instances of checking the visual element.

In general, in one aspect, a computer readable medium encoding instructions to cause a personal navigation device to receive navigation input data from a media device; repeatedly check a visual element that is generated by the personal navigation device from the navigation input data, is stored by the personal navigation device, and that indicates a current position, to determine if the visual element has been updated between two instances of checking the visual element; and compress the visual element and transmit the visual element to the media device if the visual element has not been updated between two instances of checking the visual element.

Implementations of the above may include one or more of the following features. Loss-less compression is employed to compress the visual element. It is determined if the visual element has been updated by comparing every Nth horizontal line of the visual element from a first instance of checking the visual element to corresponding horizontal lines of the visual element from a second instance of checking the visual element, wherein N has a value of at least 2. The visual element is compressed by serializing pixels of the visual element into a stream of serialized pixels and creating a description of the serialized pixels in which a given pixel color is specified when the pixel color is different from a preceding pixel color and in which the specification of the given pixel color is accompanied by a value indicating the quantity of adjacent pixels that have the given pixel color. The media device is installed within a vehicle, and the navigation input data includes data from at least one sensor of the vehicle. A piece of data pertaining to a control of the personal navigation device is transmitted to the media device to enable the media device to assign a control of the media device as a proxy for the control of the personal navigation device. The software further causes the processor to receive a indication of an actuation of the control of the media device and respond to the indication in a manner substantially identical to the manner in which an actuation of the control of the personal navigation device is responded to. The repeated checking of the visual element to determine if the visual element has been updated entails repeatedly checking the frame buffer to determine if the entirety of the frame buffer has been updated.

In general, in one aspect, a media device includes an interface capable of receiving a visual element indicating a current location from a personal navigation device; a screen; a processor structured to provide an image indicating the current location and providing entertainment information for display on the screen from at least the visual element; and a storage device in which software is stored that when executed by the processor causes the processor to define a first layer and a second layer, store the visual element in the second layer, store another visual element pertaining to the entertainment information in the first layer, and combine the first layer and the second layer to create the image with the first layer overlying the second layer such that the another visual element overlies the visual element.

In general, in one aspect, a method includes receiving a visual element indicating a current location from a personal navigation device, defining a first layer and a second layer, storing the visual element in the second layer, storing another visual element pertaining to the entertainment information in the first layer, combining the first layer and the second layer to provide an image with the first layer overlying the second layer such that the another visual element overlies the visual element, and displaying the image on a screen of a media device.

In general, in one aspect, a computer readable medium encoding instructions to cause a media device to receive a visual element indicating a current location from a personal navigation device, define a first layer and a second layer, store the visual element in the second layer, store another visual element pertaining to the entertainment information in the first layer, combine the first layer and the second layer to provide an image with the first layer overlying the second layer such that the another visual element overlies the visual element, and display the image on a screen of the media device.

Implementations of the above may include one or more of the following features. The media device of claim further includes a receiver capable of receiving a GPS signal from a satellite, wherein the processor is further structured to provide navigation input data corresponding to that GPS signal to the personal navigation device. The software further causes the processor to alter a visual characteristic of the visual element. The visual characteristic of the visual element is one of a set consisting of a color, a font and a shape. The visual characteristic that is altered is a color, and wherein the color is altered to at least approximate a color of a vehicle into which the media device is installed. The visual characteristic that is altered is a color, and wherein the color is altered to at least approximate a color specified by a user of the media device. The media device further includes a physical control, and the software further causes the processor to assign the physical control to serve as a proxy for a control of the personal navigation device. The control of the personal navigation device is a physical control of the personal navigation device. The control of the personal navigation device is a virtual control having a corresponding additional visual element that is received from the personal navigation device and that the software further causes the processor to refrain from displaying on the screen. The media device further includes a proximity sensor, and the software further causes the processor to alter at least a portion of the another visual element in response to detecting the approach of a portion of the body of a user of the media device through the proximity sensor. The another visual element is enlarged such that it overlies a relatively larger portion of the visual element.

In general, in one aspect, a media device includes at least one speaker; an interface enabling a connection between the media device and a personal navigation device to be formed, and enabling audio data stored on the personal navigation device to be played on the at least one speaker; and a user interface comprising a plurality of physical controls capable of being actuated by a user of the media device to control a function of the playing of the audio data stored on the personal navigation device during a time when there is a connection between the media device and the personal navigation device.

In general, in one aspect, a method includes detecting that a connection exists with a personal navigation device and a media device, receiving audio data from the personal navigation device, playing the audio data through at least one speaker of the media device; and transmitting a command to the personal navigation device pertaining to the playing of the audio data in response to an actuation of at least one physical control of the media device.

Implementations of the above may include one or more of the following features. The media device is structured to interact with the personal navigation device to employ a screen of the personal navigation device as a component of the user interface of the media device during a time when there is a connection between the media device and the personal navigation device. The media device is structured to assign the plurality of physical controls to serve as proxies for a corresponding plurality of controls of the personal navigation device during a time when the screen of the personal navigation device is employed as a component of the user interface of the media device. The media device is structured to transmit to the personal navigation device an indication of a characteristic of the user interface of the personal navigation device to be altered during a time when there is a connection between the media device and the personal navigation device. The characteristic of the user interface of the personal navigation device to be altered is one of a set consisting of a color, a font, and a shape of a visual element displayed on a screen of the personal navigation device. The media device is structured to accept commands from the personal navigation device during a time when there is a wireless connection between the media device and the personal navigation device to enable the personal navigation device to serve as a remote control of the media device. The media device further includes an additional interface enabling a connection between the media device and another media device through which the media device is able to relay a command received from the personal navigation device to the another media device.

Any of the foregoing methods may be implemented as a computer program product comprised of instructions that are stored on one or more machine-readable media, and that are executable on one or more processing devices. The method(s) may be implemented as an apparatus or system that includes one or more processing devices and memory to store executable instructions to implement the method(s).

The details of one or more examples are set forth in the accompanying drawings and the description below. Further features, aspects, and advantages will become apparent from the description, the drawings, and the claims.

### DESCRIPTION OF THE DRAWINGS

FIGS. 1A, 7, 8A, 8B, and 9 are block diagram of a vehicle information system.

FIG. 1B is a block diagram of a media head unit.

FIG. 1C is a block diagram of a portable navigation system.

FIG. 2 is a block diagram showing communication between a vehicle entertainment system and a portable navigation system.

FIGS. 3A through 3D, 15, 16, and 20 through 24 are examples of user interfaces.

FIG. 4 is a user interface flow chart.

FIGS. 6A through 6F are schematic diagrams of processes to update a user interface.

FIGS. 12A-12B are schematic diagrams of processes to update a user interface.

FIG. 13 is a block diagram of portions of software for communication between a vehicle entertainment system and a portable navigation system.

FIG. 14A is a perspective diagram of a vehicle information system.

FIG. 14B is a perspective diagram of a stationary information system.

FIG. 17 is a menu on a portable navigation system.

FIGS. 18 and 19 are examples of integrated menus on a vehicle entertainment system.

### DESCRIPTION

In-vehicle entertainment systems and portable navigation systems each have unique features that the other generally lacks. One or the other or both can be improved by using capabilities provided by the other. For example, a portable navigation system may have an integrated antenna, which may provide a weaker signal than an external antenna mounted on a roof of a vehicle to be used by the vehicle's entertainment system. In-vehicle entertainment systems typically lack navigation capabilities or have only limited capabilities. When we refer to a navigation system in this disclosure, we are referring to a portable navigation system (PND), which is separate from any vehicle navigation system that may be built-in to a vehicle. By portable, we mean the navigation system is removable from the vehicle and usable on its own. An entertainment system refers to an in-vehicle entertainment system. An entertainment system may provide access to, or control of, other vehicle systems, such as a heating-ventilation-air conditioning (HVAC) system, a telephone, or numerous other vehicle subsystems. Generally speaking, the entertainment system may control, or provide an interface to, systems that are entertainment and/or non-entertainment related. A communications system that can link a portable navigation system with an entertainment system can allow either system to provide services to, or receive services from, the other device.

To this end, described herein is a system that integrates elements of an entertainment system and a navigation system. Such a system has advantages. For example, it allows information to be transmitted between the entertainment system and the navigation system, e.g., when one system has information that the other system lacks. In one example, a navigation system may store its last location when the navigation system is turned-off. However, the information about the navigation system's last location may not be reliable because the navigation system may be moved while it is off. Thereafter, when the navigation system is first turned-on, it has to rely on satellite signals to determine its current location. The process of acquiring satellite signals to obtain accurate current location information often takes five minutes or more. On the other hand, a vehicle entertainment system may have accurate current location information readily available, because a vehicle generally does not move when it is not operational. The entertainment system may provide the navigation system with this information when the navigation system is first turned-on, thereby enabling the navigation system to function without waiting for its satellite signals. The vehicle entertainment system may store its last location before the vehicle is turned off. When the vehicle is later started, it can provide this information immediately to the navigation system. A vehicle entertainment system may be equipped with global positioning system capability for tracking its current position. At any time when a portable navigation device is connected to the vehicle, the vehicle entertainment system may provide its current location information to the navigation system. The navigation system can use this information until it acquires satellite signals on its own, or it could rely solely on the location information provided from the vehicle.

An integrated entertainment and navigation system, such as those described herein, also can provide “dead reckoning” when the navigation system loses satellite signals, e.g., when the navigation system is in a tunnel or is surrounded by tall buildings. Dead reckoning is a process of computing a current location based on vehicle data, such as speed, longitude, and latitude. When the navigation system loses communication with a satellite, an integrated system can obtain the vehicle data from the vehicle via the entertainment system interface, compute the current location of the vehicle, and supply that information to the navigation system. Alternatively, if the navigation system has the capability, the vehicle can provide data from the vehicle sensors to the navigation system, and the navigation system can use this data to perform dead reckoning until satellite signals are re-acquired. The vehicle sensor data can be continuously provided to the navigation system, so that the navigation system can use satellite signals and vehicle data in combination to improve its ability to track the vehicle current location.

An integrated system also allows a driver to focus on only one screen, instead of dividing attention between two (or more) screens. For example, an integrated system may display navigation information (maps, routes, etc.) on the screen of the entertainment system. An integrated system may also overlay the display of information about an audio source over a view of a map, thereby providing a combined display of information from two separate systems, one of which is not permanently integrated into the vehicle.

Navigation and entertainment systems can include both graphical user interfaces and human-machine user interfaces.

In general, a graphical user interface (GUI) is an interface that is often displayed on a screen and that contains elements, such as menus and icons. A menu may include a list of items that a user can browse through in order to select a particular item. A menu item can be, e.g., an icon or a string of characters, or both. Generally speaking, an icon is a graphic symbol associated with a menu item or a functionality.

A human-machine user interface refers to the physical aspect of a system's user interface. A human-machine user interface can contain elements such as switches, knobs, buttons, and the like. For example, an on/off switch is an element of the human-machine user interfaces of most systems. In an entertainment system, a human-machine user interface may include elements such as a volume control knob, which a user can turn to adjust the volume of the entertainment system, and a channel seeking button, which a user can press to seek the next radio station that is within range. One or more of knobs may be a concentric knob. A concentric knob is an inner knob nested inside an outer knob, with the inner knob and the outer knob controlling different functions.

A navigation system is often controlled via a touch-screen graphical user interface with touch-sensitive menus. An entertainment system is often controlled via physical buttons and knobs. For example, a user may press a button to select a pre-stored radio station. A user may turn a knob to increase or decrease the volume of a sound system. An integrated system, such as those described herein, could be less user-friendly if the controls for its two systems were to remain separate. For example, an entertainment system and a navigation system may be located far from each other. A driver may have to stretch out to reach the control of one system or the other.

Thus, the integrated system described herein also integrates elements of the graphical and human-machine interfaces of its two systems, namely the entertainment and navigation system. Accordingly, the user interface of an integrated system may be a combination of portions of the graphical user interface and/or human-machine user interface elements from both the entertainment system and the navigation system.

Elements contained in a user interface of a system that are used to control that system are referred to herein as control features. To integrate user interfaces of a navigation system and entertainment system, some functions on the navigation system that are activated using the control features of the navigation system will be chosen and activated using control features of the entertainment system. This is referred to as “mapping” in this application. During a mapping process, elements of the user interface of the navigation system may be mapped to the elements of the user interface of the entertainment of the same modality or different modalities. For example, a button press on the navigation system may be translated to a button press on the entertainment system, or it could be translated to a knob rotation. If both the navigation system and the entertainment system have a touch screen interface, then the mapping may be similar for most elements (touch screen to touch screen). But, there may still be some differences. For example, the touch screen in the entertainment system may be larger than the touch screen of the navigation system, and it may accommodate more icons on the display. Also, some touch functions on the navigation system may still be mapped to some other modality on the entertainment system human-machine user interface, such as a button press on the entertainment system.

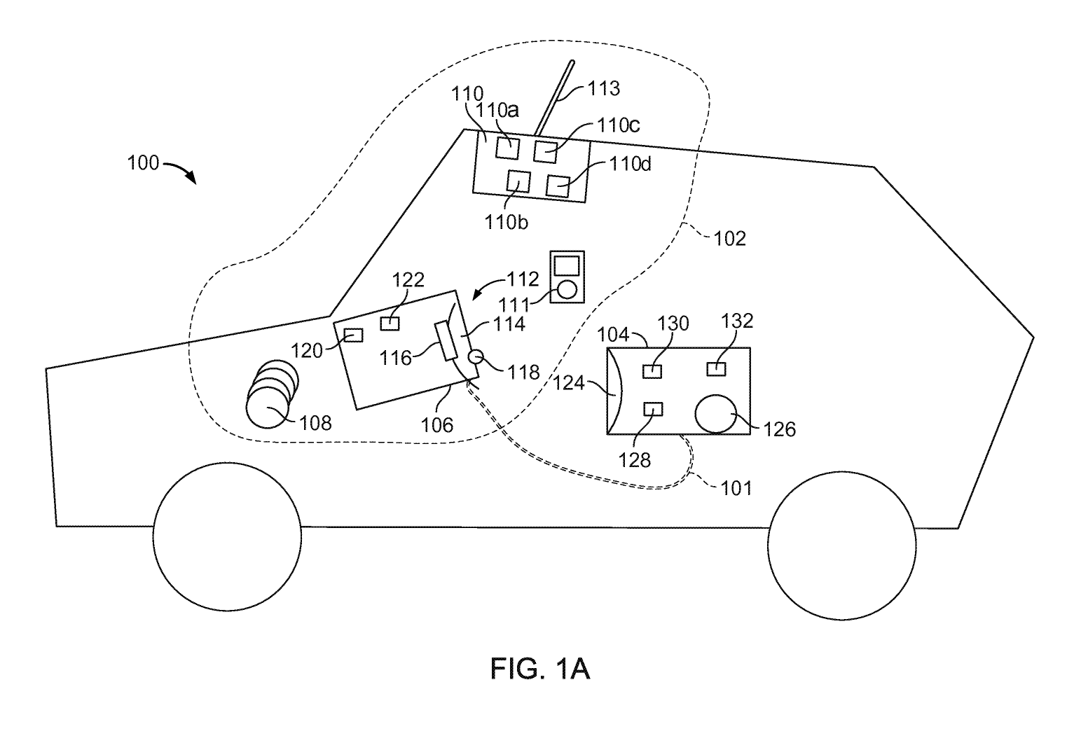

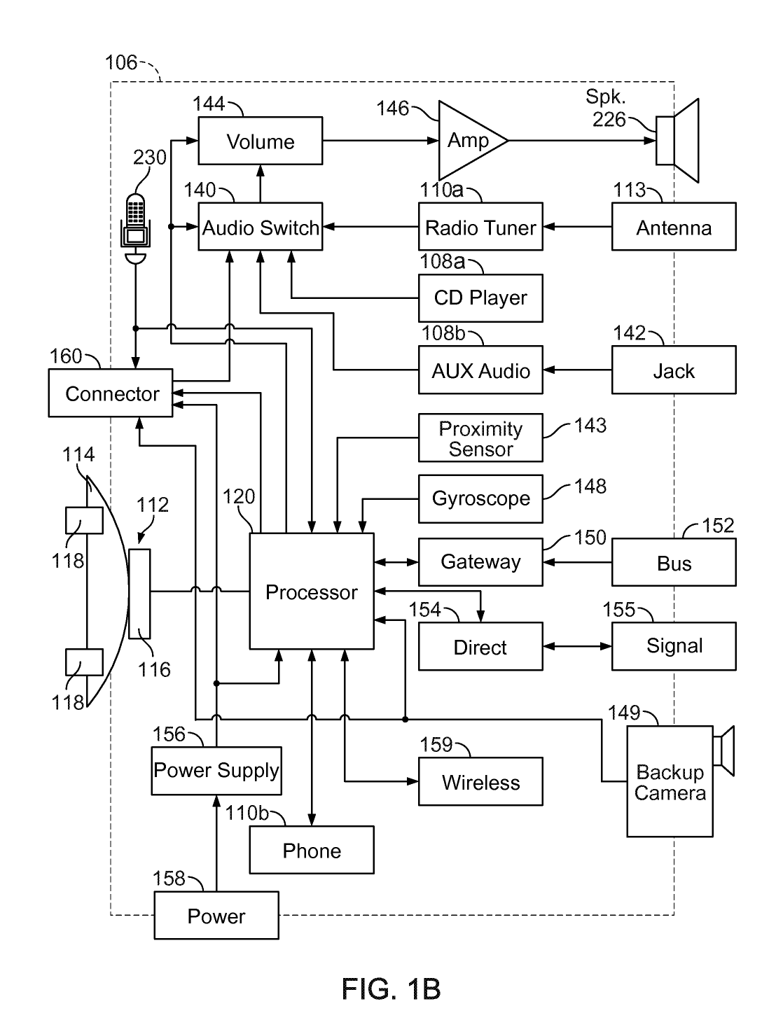

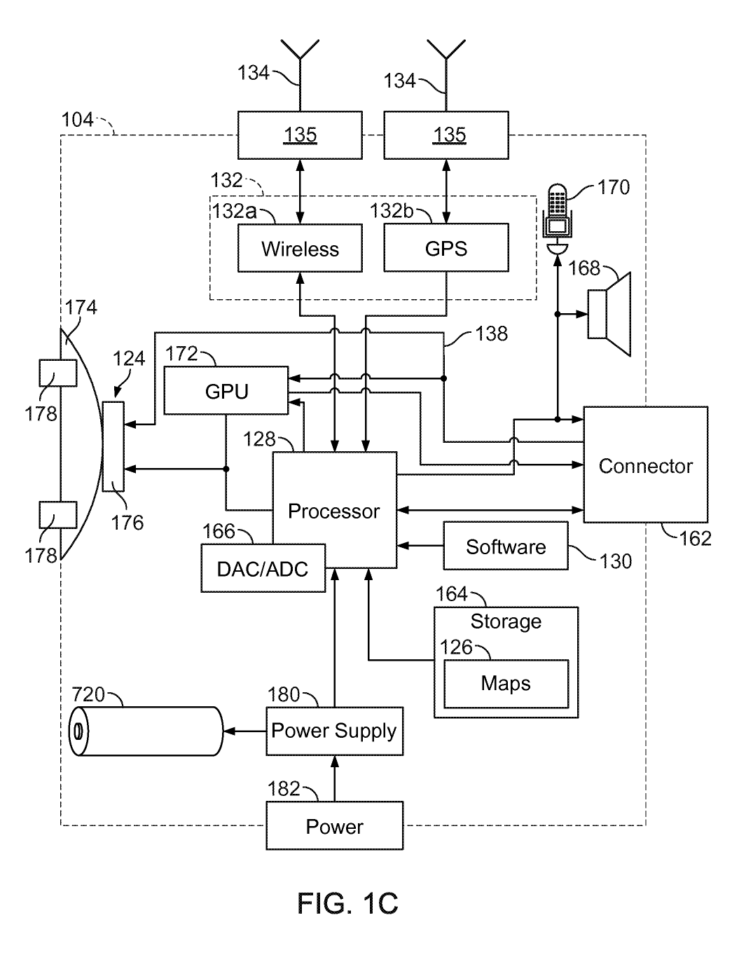

Referring to FIG. 1A, that figure illustrates an integrated system of an entertainment system and a navigation system. An entertainment system 102 and a navigation system 104 may be linked within a vehicle 100 as shown in FIG. 1A. In some examples, the entertainment system 102 includes a head unit 106, media sources 108, and communications interfaces 110. The navigation system 104 is connected to one or more components of the entertainment system 102 through a wired or wireless connection 101. The media sources 108 and communications interfaces 110 may be integrated into the head unit 106 or may be implemented separately. The communications interfaces may include radio receivers 110a for FM, AM, or satellite radio signals, a cellular interface 110b for two-way communication of voice or data signals, a wireless interface 110c for communicating with other electronic devices such as wireless phones or media players 111, and a vehicle communications interface 110d for receiving data from within the vehicle 100. The interface 110c may use, for example, Bluetooth®, WiFi®, WiMax® or any other wireless technology. References to Bluetooth in the remainder of this description should be taken to refer to Bluetooth or to any other wireless technology or combination of technologies for communication between devices.

The communications interfaces 110 may be connected to at least one antenna 113, which may be a multifunctional antenna capable of receiving AM, FM, satellite radio, GPS, Bluetooth, etc., transmissions. The head unit 106 also has a user interface 112, which may be a combination of a graphics display screen 114, a touch screen sensor 116, and physical knobs and switches 118, and may include a processor 120 and software 122. A proximity sensor 143 (shown in FIG. 1B) may be used to detect when a user's hand is approaching one or more controls, such as those described above. The proximity sensor 143 may be used to change information on graphics display screen 114 in conjunction with one or more of the controls.

In some examples, the navigation system 104 includes a user interface 124, navigation data 126, a processor 128, navigation software 130, and communications interfaces 132. The communications interface may include GPS, for finding the system's location based on GPS signals from satellites or terrestrial beacons, a cellular interface for transmitting voice or data signals, and a wireless interface for communicating with other electronic devices, such as wireless phones.

In some examples, the various components of the head unit 106 are connected as shown in FIG. 1B. An audio switch 140 receives audio inputs from various sources, including the radio tuner 110a that is connected to antenna 113, media sources such as a CD player 108a and an auxiliary input 108b, which may have a jack 142 for receiving input from an external source. The audio switch 140 also receives audio input from the navigation system 104 (not shown) through a connector 160. The audio switch sends a selected audio source to a volume controller 144, which in turn sends the audio to a power amplifier 146 and a loudspeaker 226. Although only one loudspeaker 226 is shown, the vehicle 100 typically has several. In some examples, audio from different sources may be directed to different loudspeakers, e.g., audible navigation prompts may be sent only to the loudspeaker nearest the driver while an entertainment program continues playing on other loudspeakers. In some examples, an audio switch may also mix signals by adjusting the volumes of different signals. For example, when the entertainment system is outputting an audible navigation prompt, a contemporaneous music signal may be reduced in volume so that the navigation prompt is audible over the music.

The audio switch 140 and the volume controller 144 are both controlled by the processor 120. The processor may receive inputs from the touch screen 116, buttons 118, and proximity sensor 143, and outputs information to the display screen 114. The proximity sensor 143 can detect the proximity of a user's hand or head. The input from the proximity sensor can be used by the processor 120 to decide where output information should be displayed or to which speaker audio output should be routed. In some examples, inputs from proximity sensor 143 can be used to control the portable navigation system 104. As an illustration, when the proximity sensor 143 detects that a user's hand is close to the touch screen of the vehicle, a command is issued to the portable navigation device in response to the detection. The type of command that is issued depends, e.g., on the content of the touch screen at the time of detection. For example, if the touch screen relates to navigation, and has a touch-based control therefor, an appropriate navigation command may be issued via the proximity sensor. Thus, the system described herein detects proximity to the human-machine interface of the vehicle, and a command is issued to the navigation device to cause it to respond in some manner to the sensed proximity to the vehicle controls. In another example, if the entertainment system is set up to control the navigation system, and the system currently is in map view, when the users hand is sensed near the vehicle human-machine interface, icons for zooming the map may show up on screen. The system sends a command to the navigation system to provide these icons, if the system does not already have them.

In some examples, some parts of the interface 112 may be physically separate from the components of the head unit 106.

The processor may receive inputs from individual devices, such as a gyroscope 148 and backup camera 149. The processor may exchange information via a gateway 150 with an information bus 152, and process signal inputs from a variety of sources 155, such as vehicle speed sensors or the ignition switch. Whether particular inputs are direct signals or are communicated over the bus 152 will depend on the architecture of the vehicle 100. The vehicle may be equipped with at least one bus for communicating vehicle operating data between various modules. There may be an additional bus for entertainment system data. The head unit 106 may have access to one or more of these busses. A gateway module in the vehicle (not shown) may convert data from a bus that is not available to the head unit 106 to a bus that is available to the head unit 106. The head unit 106 may be connected to more than one bus and may perform the conversion function for other modules in the vehicle. The processor may also exchange data with a wireless interface 159. This can provide connections to media players or wireless telephones, for example, which may be inside of, or external to, the vehicle. The head unit 106 may also have a wireless telephone interface 110b built-in. Any of the components shown as part of the head unit 106 in FIG. 1B may be integrated into a single unit or may be distributed in one or more separate units. The head unit 106 may use a gyroscope 148, or other vehicle sensors, such as a speedometer, steering angle sensor, accelerometer (not shown), to sense speed, acceleration and rotation (e.g., turning). Any of the inputs shown connected to the processor may also be passed on directly to the connector 160, as shown for the backup camera 149. Power for the entertainment system may be provided through the power supply 156 by power 158, a power source.

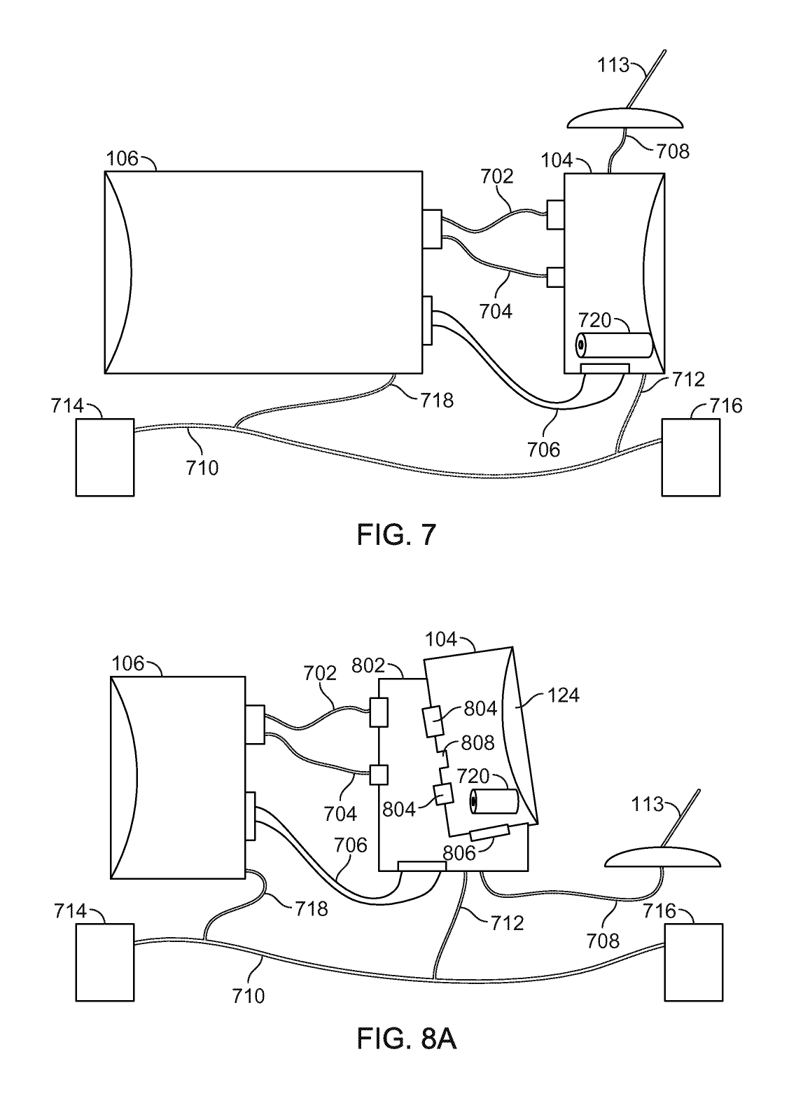

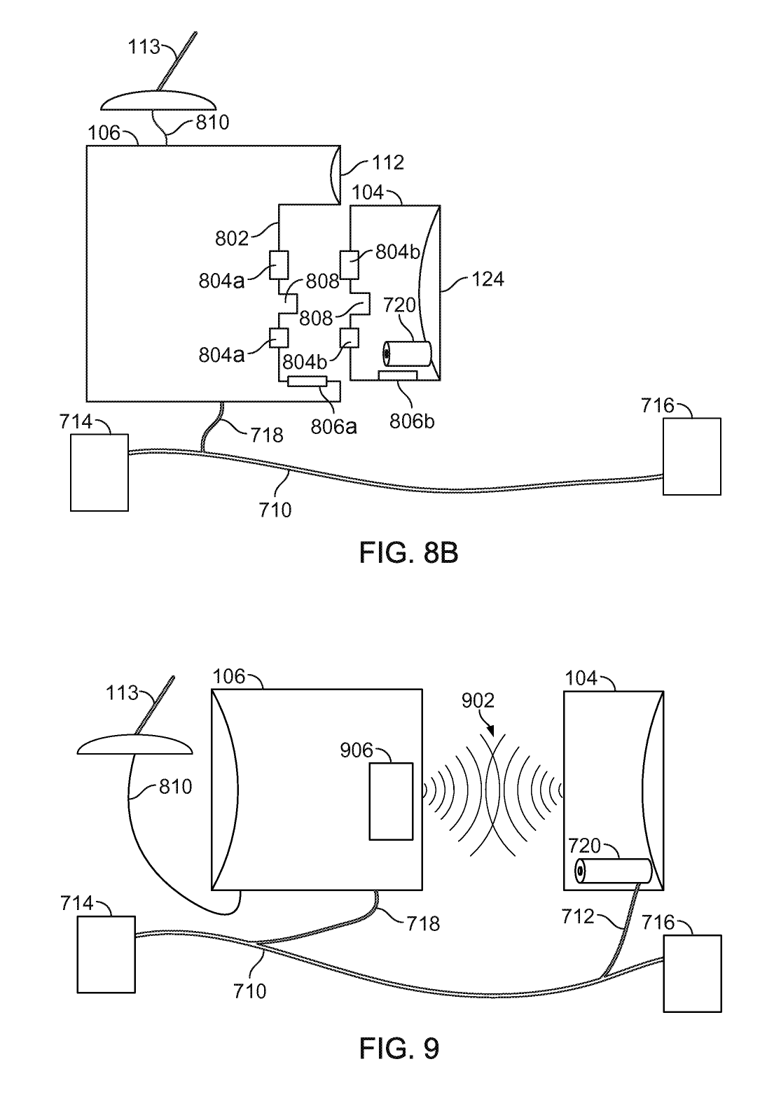

As noted above, the connection from the entertainment system 102 to the navigation system 104 may be wireless. As such, the arrows between various parts of the entertainment system 102 and the connector 160 in FIG. 1B would run instead between the various parts and the wireless interface 159. In wired examples, the connector 160 may be a set of standard cable connectors, a customized connector for the navigation system 104, or a combination of connectors. Some examples are discussed with regard to FIGS. 7 and 8A, below.

The various components of the navigation system 104 may be connected as shown in FIG. 1C. The processor 128 receives inputs from communications interfaces 132, including a wireless interface (such as a Bluetooth interface) 132a and a GPS interface 132b, each with its own antenna 134 or a shared common antenna. The GPS interface 132b receives signals from satellites or other transmitters and uses those signals to derive the system's location. The wireless interface 132a and GPS interface 132b may include connections 135 for external antennas or the antennas 134 may be internal to the navigation system 104. The processor 128 also may also transmit and receive data through a connector 162, which mates to the connector 160 of the head unit 106 (in some examples with cables in between, as discussed below). Any of the data communicated between the navigation system 104 and the entertainment system 102 may be communicated though either the connector 162, the wireless interface 132a, or both. An internal speaker 168 and microphone 170 are connected to the processor 128. The speaker 168 may be used to output audible navigation instructions, and the microphone 170 may be used to capture a speech input and provide it to the processor 128 for voice recognition. The speaker 168 may also be used to output audio from a wireless connection to a wireless phone using wireless interface 132a or via connector 162. The microphone 170 may also be used to pass audio signals to a wireless phone using wireless interface 132a or via connector 162. Audio input and output may also be provided by the entertainment system 102 to the navigation system 104. The navigation system 104 includes a storage 164 for map data 126, which may be, for example, a hard disk, an optical disc drive or flash memory. This storage 164 may also include recorded voice data to be used in providing the audible instructions output to speaker 168. Alternatively, navigation system 104 could run a voice synthesis routine on processor 128 to create audible instructions on the fly, as they are needed. Software 130 may also be in the storage 164 or may be stored in a dedicated memory.

The connector 162 may be a set of standard cable connectors, a customized connector for the navigation system 104 or a combination of connectors.

A graphics processor (GPU) 172 may be used to generate images for display through the user interface 124 or through the entertainment system 102. The GPU 172 may receive video images from the entertainment system 102 directly through the connector 162 or through the processor 128 and process these for display on the navigation system's user interface 124. Alternatively, video processing could be handled by the main processor 128, and the images may be output through the connector 162 by the processor 128 or by the GPU 172. The processor 128 may also include digital/analog converters (DACs and ADCs) 166, or these functions may be performed by dedicated devices. The user interface 124 may include an LCD or other video display screen 174, a touch screen sensor 176, and controls 178. In some examples, video signals, such as from the backup camera 149, are passed directly to the display 174 via connector 162 or wireless interface 132a. A power supply 180 regulates power received from an external source 182 or from an internal battery 720. The power supply 180 may also charge the battery 720 from the external source 182. Connection to the external source 182 may also be available through the connector 162. Communication line 138 that connects the connector 162 and the user interface 124 may be used as a backup camera signal line to pass the backup camera signals to the navigation system. In this way, images of the backup camera of the entertainment system can be displayed on the navigation system's screen.

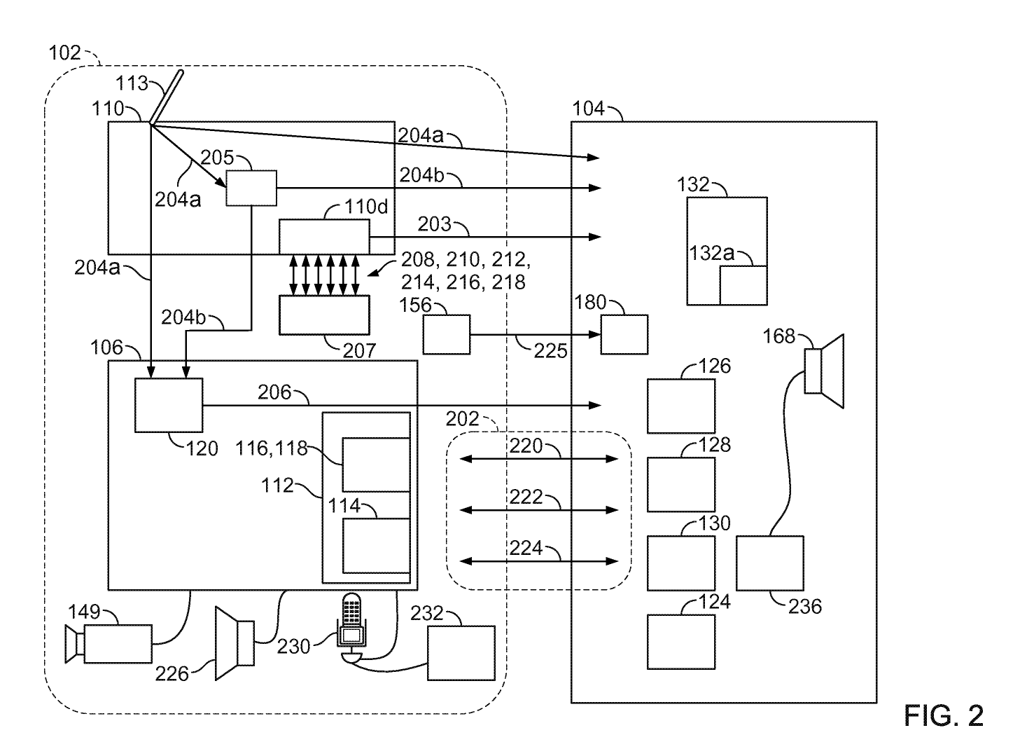

In some examples, as shown in FIG. 2, the navigation system 104 can use signals available through the entertainment system 102 in place of or in addition to its internally-derived navigational data to improve the operation of its navigation function. The external antenna 113 on the vehicle 100 may provide a better GPS signal 204a than one integrated into the navigation system 104. Such an antenna 113 may be connected directly to the navigation system 104, as discussed below, or the entertainment system 102 may relay the signals 204a from the antenna after tuning them itself with a tuner 205 to create a new signal 204b. In some examples, the entertainment system 102 may use its own processor 120 in the head unit 106 or elsewhere to interpret signals 204a received by the antenna 113 or signals 204b received from the tuner 205 and relay longitude and latitude data 206 to the navigation system 102. This may also be used when the navigation system 104 requires some amount of time to determine a location from GPS signals after it is activated—the entertainment system 102 may provide a current location to the navigation system 104 as soon as the navigation system 104 is turned on or connected to the vehicle, allowing it to begin providing navigation services without waiting to determine the vehicle's location. Because it is connected to the vehicle 100 through a communications interface 110d (shown connected to a vehicle information module 207), the entertainment system 102 may also be able to provide the navigation system 104 with data 203 not otherwise available to the navigation system 104, such as vehicle speed 208, acceleration 210, steering inputs 212, and events such as braking 214, airbag deployment 216, or engagement 218 of other safety systems such as traction control, roll-over control, tire pressure monitoring and anything else that is communicated over the vehicle's communications networks.

The navigation system 104 can use the data 203 for improving its calculation of the vehicle's location, for example, by combining the vehicle's own speed readings 208 with those derived from GPS signals 204a, 204b, or 206, or the navigation system's own GPS signals 132b (shown in FIG. 1C), the navigation system 104 can make a more accurate determination of the vehicle's true speed. Signal 206 may also include gyroscope information that has been processed by processor 120 as mentioned above. If a GPS signal 204a, 204b, or 206 is not available, for example, if the vehicle 100 is surrounded by tall buildings or in a tunnel and does not have a line of sight to enough satellites, the speed 208, acceleration 210, steering 212, and other inputs 214 or 218 characterizing the vehicle's motion can be used to estimate the vehicle's course by dead reckoning. Gyroscope information that has been processed by processor 120 and is provided by 206 may also be used. In some examples, the computations of the vehicle's location based on information other than GPS signals may be performed by the processor 120 and relayed to the navigation system in the form of a longitude and latitude location. If the vehicle has its own built-in navigation system, such calculations of vehicle location may also be used by that system. In some examples, vehicle sensor information can be passed to the navigation system, and the navigation system can estimate the vehicle's position by performing dead reckoning calculations within the navigation device (e.g. processor 128 runs a software routine to calculate position using the vehicle sensor data).

Other data 218 from the entertainment system of use to the navigation system may include traffic data received through the radio receiver 110a and antenna 113 or wireless phone interface, collision data, and vehicle status such as doors opening or closing, engine start, headlights or internal lights turned on, and audio volume. This can be used for such things as changing the display of the navigation system to compensate for ambient light, locking-down the user interface while driving, or calling for emergency services in the event of an accident if the navigation system has a wireless phone capability and the car does not have its own wireless phone interface. For example, the navigation system may use data 218, especially the traffic data, for automatic recalculation of a planned route to minimize travel delays or to adjust the navigation system routing algorithm. In some examples, the entertainment system may notify the navigation system that a collision has occurred, e.g., via data 218. The navigation system, after receiving the notification, may send an emergency number and/or a verbal notification that are pre-stored on the navigation system to the entertainment system. This information may be used to make a telephone call to the appropriate emergency personnel. The telephone call may be a “hands-free” call, e.g., one that is made automatically without requiring the user to physically dial the call. Such a call may be initiated via the verbal notification output by the navigation system, for example.

The navigation system 104 may exchange, with the entertainment system 102, data including video signals 220, audio signals 222, and commands or information 224, which are collectively referred to as data 202. Power for the navigation system 104, for charging or regular use, may be provided from the entertainment system's power supply 156 to the navigation system's power supply 180 through connection 225. If the navigation system's communications interfaces 132 include a wireless phone interface 132a and the entertainment system 102 does not have one, the navigation system 104 may enable the entertainment system 102 to provide hands-free calling to the driver through the vehicle's speakers 226 and a microphone 230. The microphone and speakers of the navigation system may be used to provide hands-free functionality. The vehicle entertainment system speakers and microphone may also be used to provide hands-free functionality. Alternatively, some combination thereof may be used, such as using the vehicle speakers and the navigation system's microphone (e.g., for cases where the vehicle does not have a microphone). The audio signals 222 carry the voice data from the driver to the wireless phone interface 132a in the navigation system and carry any voice data from a call back to the entertainment system 202. The audio signals 222 can also be used to transfer audible instructions such as driving directions or voice recognition acknowledgements from the navigation system 104 to the head unit 106 for playback on the vehicle's speakers 226 instead of using a built-in speaker 168 in the navigation system 104.

The audio signals 222 may also be used to provide hands-free operation from one device to another. In one example, components of hands-free system 232 may include a pre-amplifier for a microphone, an amplifier for speakers, digital/analog converters, logic circuitry to route signals appropriately, and signal processing circuitry (for, e.g., equalization, noise reduction, echo cancellation, and the like). If the entertainment system 102 has a microphone 230 for either a hands-free system 232 or other purpose, it may receive voice inputs from microphone 230 and relay them as audio signals 222 to the navigation system 104 for interpretation by voice recognition software on the navigation system and receive audio responses 222, command data and display information 224, and updated graphics 220 back from the navigation system 104. Alternatively, the entertainment system 102 may also interpret the voice inputs itself, using its own voice recognition software, which may be a part of software 122, to send control commands 224 directly to the navigation system 204. If the navigation system 104 has a microphone 170 for either a hands-free system 236 or other purposes, its voice inputs can be interpreted by voice recognition software which may be part of software 130 on the navigation system 104 and may be capable of controlling aspects of the entertainment system by sending control commands 224 directly to the entertainment system 102. In some examples, the navigation system 104 also functions as a personal media player (e.g., an MP3 player), and the audio signals 222 may carry a primary audio program to be played back through the vehicle's speakers 226. In some examples, the navigation system 104 has a microphone 170 and the entertainment system 102 includes voice recognition software. The navigation system may receive voice input from microphone 170 and replay that voice input as audio signals to the entertainment system. The voice recognition software on the entertainment system interprets the audio signals as commands. For example, the voice recognition software, may decode commands from the audio signals. The entertainment system may send the commands to the navigation system for processing or process the commands itself.

In summary, voice signals are transmitted from one device that has a microphone to a second device that has voice recognition software. The device that has the voice recognition software will interpret the voice signals as commands. The device that has the voice recognition could send command information back to the other device, or it could execute a command itself.

The general concept is that the vehicle entertainment system and the portable system can be connected by the user, and that there is voice recognition capability in one device (any device that has voice recognition will generally have a microphone built into it). Upon connecting the two devices, voice recognition capability in one device is made available to the other device. The voice recognition can be in the portable device, and it can made available to the vehicle when connected, or the voice recognition can be in the vehicle media system, and be made available to the portable device.

In some examples, the head unit 106 can receive inputs on its user interface 116 or 118 and relay these to the navigation system 104 as commands 224. In this way, the driver only needs to interact with one device, and connecting the navigation system 104 to the entertainment system 102 allows the entertainment system 102 to operate as if it included navigation features. In such a mode, in some examples, video signals 220 allow the navigation system 104 to display its user interface 124 through the head unit 106's screen 114.

The navigation system 104 may be used to display images from the entertainment system 102, for example, from the backup camera 149 or in place of using the head unit's own screen 114. Such images can be passed to the navigation system 104 using the video signals 220. This has the advantage of providing a graphical display screen for a head unit 106 that may have a more-limited display 114. For example, images from the backup camera 149 may be relayed to the navigation system 104 using video signals 220 and, when the vehicle is put in to reverse, as indicated by a direct input 154 or over the vehicle bus 152 (FIG. 1B), this can be communicated to the navigation system 104 using the command and information link 224. At this point, the navigation system 104 can automatically display the backup camera's images. This can be advantageous when the navigation system 104 has a better or move-visible screen 174 than the head unit 106 has, giving the driver the best possible view.

In cases where the entertainment system 102 does include navigation features, the navigation system 104 may be able to supplement or improve on those features, for example, by providing more-detailed or more-current maps though the command and information link 224 or by offering better navigation software or a more powerful processor. In some examples, the head unit 106 may be equipped to transmit navigation service requests over the command and information link 224 and receive responses from the navigation system's processor 128. In some examples, the navigation system 104 can supply software 130 and data 126 to the head unit 106 to use with its own processor 120. In some examples, the entertainment system 102 may download additional software to the navigation system, for example, to update its ability to calculate location based on the specific information that vehicle makes available.

By providing navigation data through the entertainment system, it is possible to mount the navigation system in the vehicle, including in locations that are not necessarily or easily visible to the driver, and still use the navigation system. Connections (e.g., interfaces, data formats, and the like) between the navigation system and the entertainment system may be standard or proprietary. A standard connection may allow navigation systems from various manufacturers to work in a vehicle without customization. If the navigation system uses a proprietary connection, the entertainment system 102 may include software or hardware that allows it to interface with such a connection, for example, by converting between file and command formats as required.

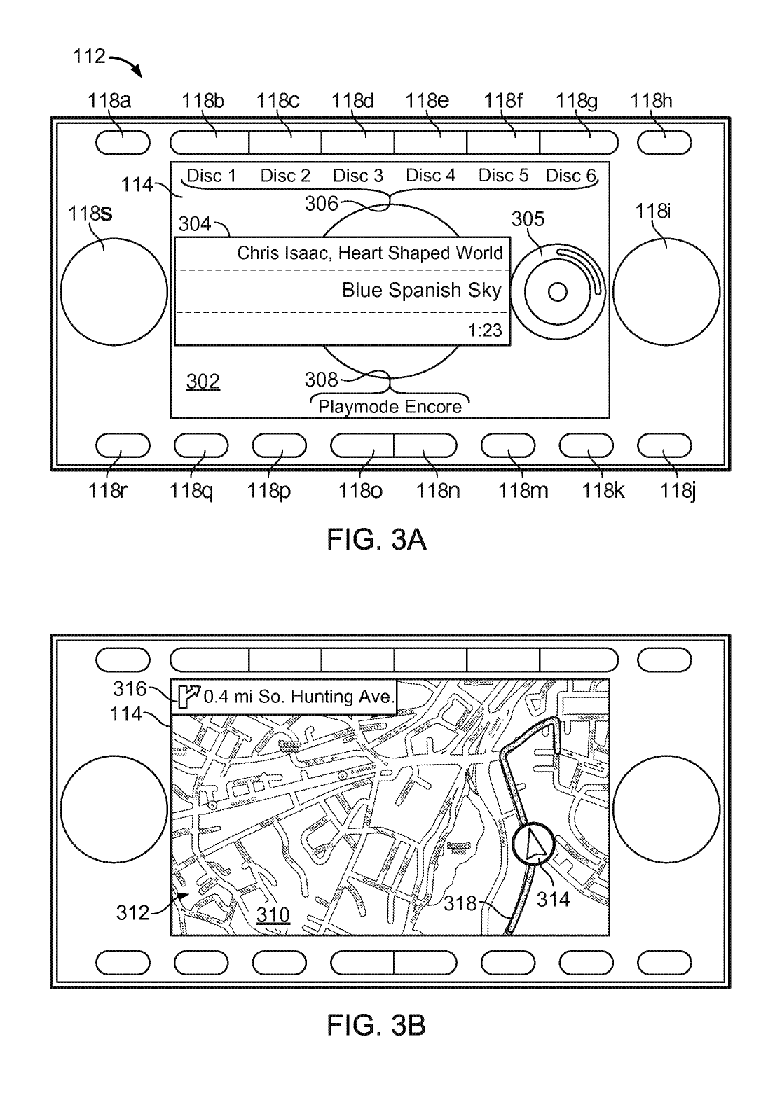

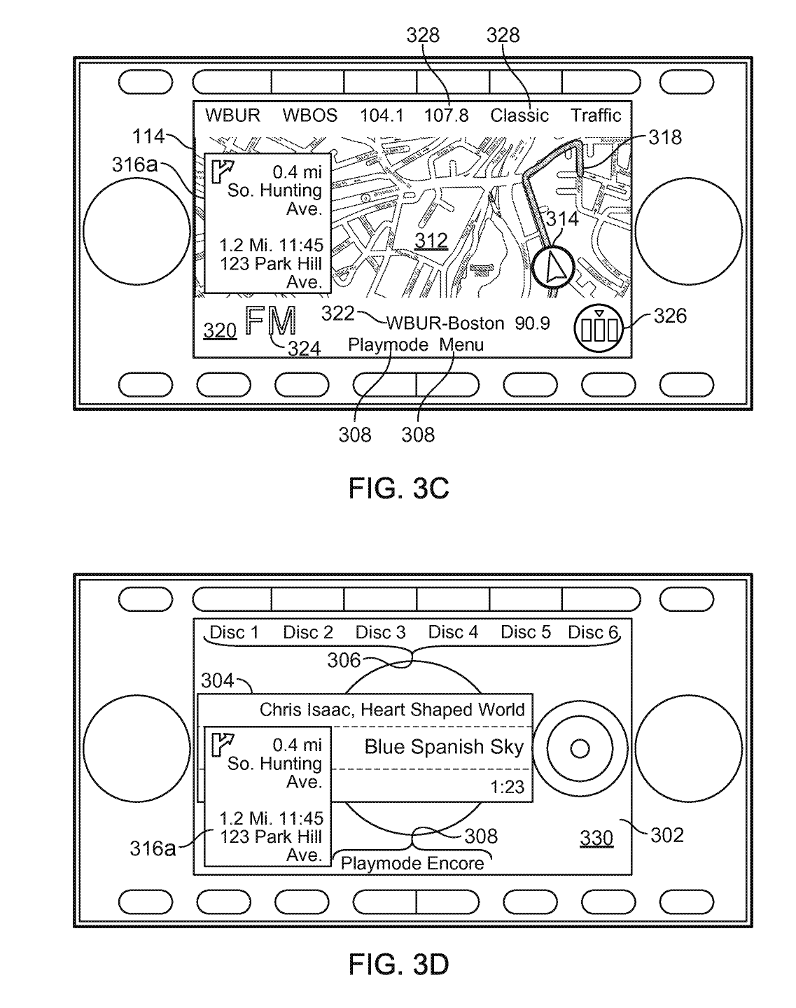

In some examples, the navigation system's interface 124 is relayed through the head unit's interface 112 as shown in FIGS. 3A-3D. In this example, the user interface 112 includes a screen 114 surrounded by buttons and knobs 118a-118s. Initially, as shown in FIG. 3A, the screen 114 shows an image 302 unrelated to navigation, such as an identification 304 and status 305 of a song currently playing on the CD player 108a. Other information 306 indicates what data is on CDs selectable by pressing buttons 118b-118h and other functions 308 available through buttons 118n and 118o. Pressing a navigation button 118m causes the screen 114 to show an image 310 generated by the navigation system 104, as shown in FIG. 3B. This image includes a map 312, the vehicle's current location 314, the next step of directions 316, and a line 318 showing the intended path. This image 310 may be generated completely by the navigation system 104 or by the head unit 106 as instructed by the navigation system 104, or a combination of the two. Each of these methods is discussed below.

In the example of FIG. 3C, a screen 320 combines elements of the navigation screen 310 with elements related to other functions of the entertainment system 102. In this example, an indication 322 of what station is being played, the radio band 324, and an icon 326 indicating the current radio mode use the bottom of the screen, together with function indicators 308 and other radio stations 328 displayed at the top, with the map 312, location indicator 314, a modified version 316a of the directions, and path 318 in the middle. The directions 316a may also include point of interest information, such as nearby gas stations or restaurants, the vehicle's latitude and longitude, current street name, distance to final destination, time to final destination, and subsequent or upcoming driving instructions such as “in 0.4 miles, turn right onto So. Hunting Ave.”

In the example of FIG. 3D, a screen image 330 includes the image 302 for the radio with the next portion of the driving directions 316 from the navigation system overlaid, for example, in one corner. Such a screen may be displayed, for example, if the user wishes to adjust the radio while continuing to receive directions from the navigation system 104, to avoid missing a turn. Once the user has selected a station, the screen may return to the screen 320 primarily showing the map 312 and directions 316.

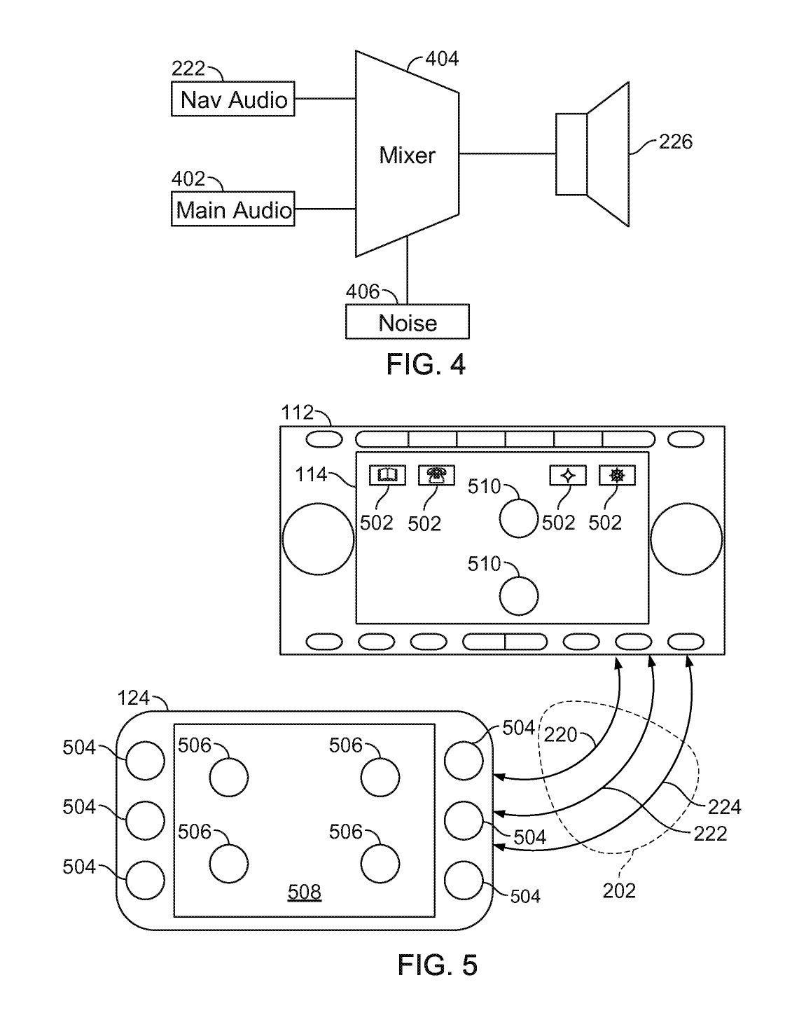

Audio from the navigation system 104 and entertainment system 102 may similarly be combined, as shown in FIG. 4. The navigation system may generate occasional audio signals, such as a voice prompts telling the driver about an upcoming turn, which are communicated to the entertainment system 102 through audio signals 222 as described above. At the same time, while the entertainment system 102 is likely to generate continuous audio signals 402, such as music from the radio or a CD. In some examples, a mixer 404 in the head unit 106 determines which audio source should take priority and directs that one to speakers 226. For example, when a turn is coming up and the navigation system 104 sends an announcement over audio signals 222, the mixer may reduce the volume of music and play the turn instructions at a relatively loud volume. If the entertainment system is receiving vehicle information 203, it may also base the volume on factors 406 that may cause ambient noise, e.g., increasing the volume to overcome road noise based on the vehicle speed 208. In some examples, the entertainment system may include a microphone to directly discover noise levels 406 and compensate for them either by raising the volume or by actively canceling the noise. The audio from the lower-priority source may be silenced completely or may only be reduced in volume and mixed with the louder high-priority audio. The mixer 404 may be an actual hardware component or may be a function carried out by the processor 120.

When the head unit's interface 112 is used in this manner as a proxy for the navigation system's interface 124, in addition to using the screen 114, it may also use the head unit's inputs 118 or touch screen 116 to control the navigation system 104. In some examples, as shown in FIGS. 3A-3D, some buttons on the head unit 106 may not have dedicated functions, but instead have context-sensitive functions that are indicated on the screen 114. Such buttons or knobs 118i and 118s can be used to control the navigation system 104 by displaying relevant features 502 on the screen 114, as shown in FIG. 5. These might correspond to physical buttons 504 on the navigation system 104 or they might correspond to controls 506 on a touch-screen 508. If the head unit's interface 112 includes a touch screen 116, it could simply be mapped directly to the touch screen 506 of the navigation system 104 or it could display virtual buttons 510 that correspond to the physical buttons 504. The amount and types of controls displayed on the screen 114 may be determined by the specific data sent from the navigation system 104 to the entertainment system 102. For example, if point of information data is sent, then one of the virtual buttons 510 may represent the nearest point of information, and if the user selects it, additional information may be displayed.

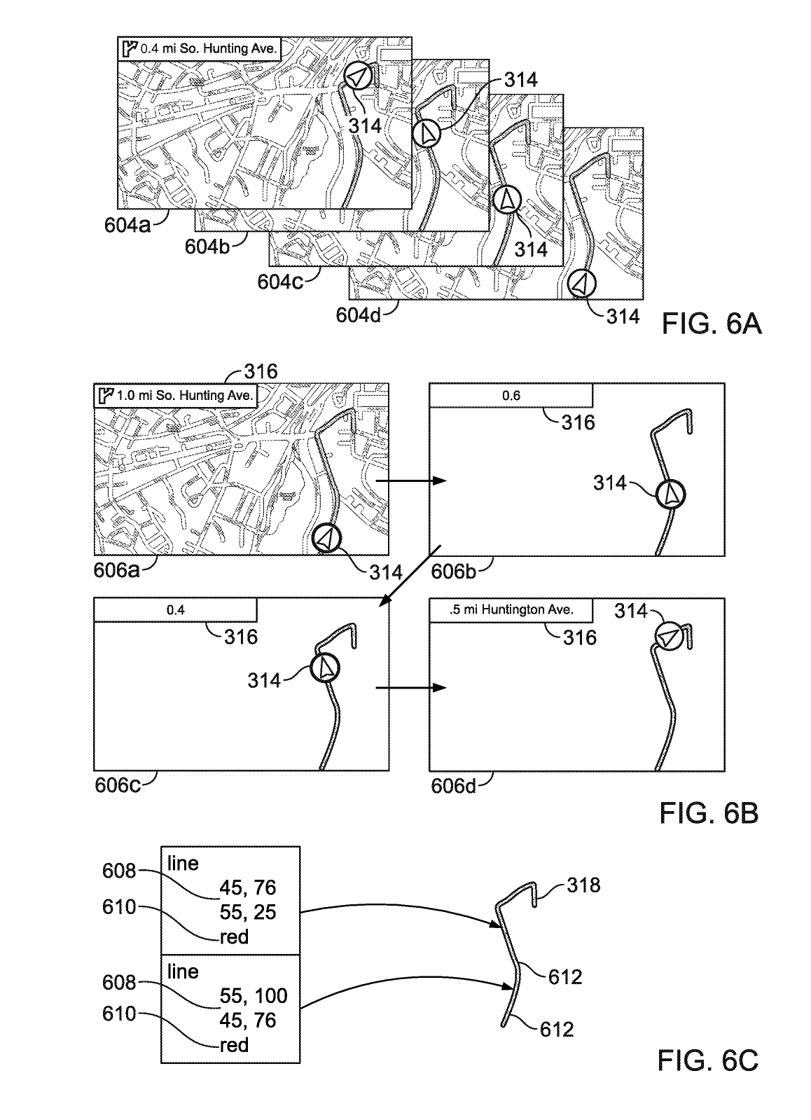

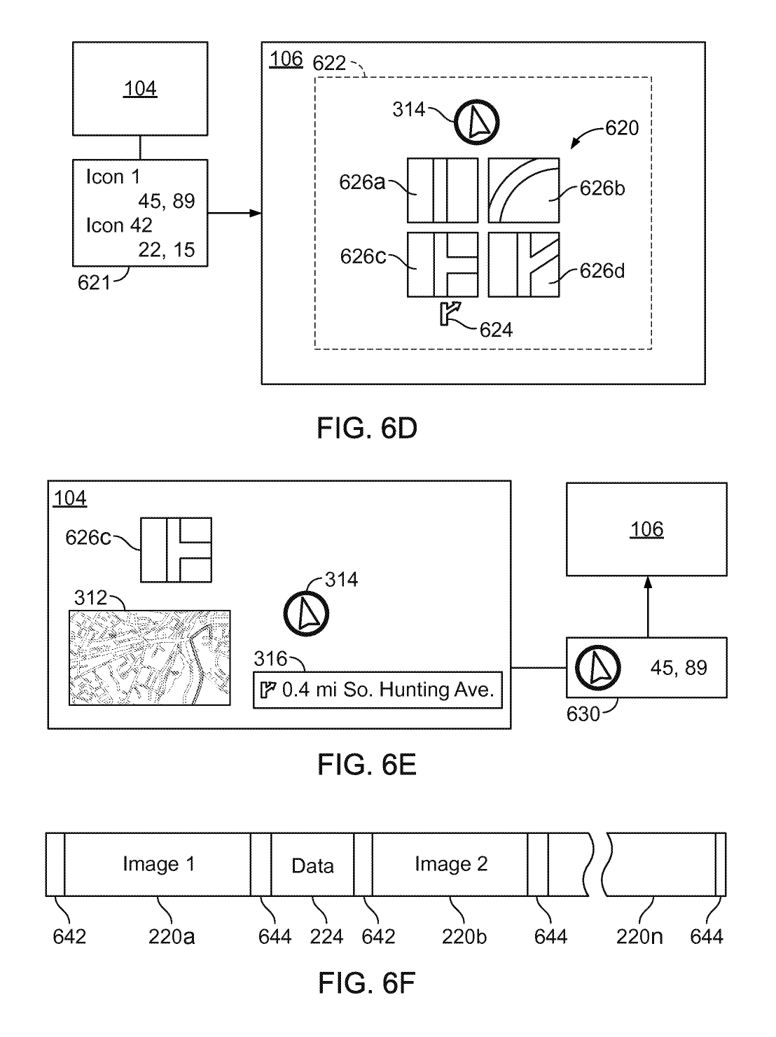

Several methods can be used to generate the screen images shown on the screen 114 of the head unit 106. In some examples, as shown in FIGS. 6A-6C, a video image 604a is transmitted from the navigation system 104 to the head unit 106. This image 604a could be transmitted as a data file using an image format such as BMP, JPEG or PNG or the image may be streamed as an image signal over a connection such as DVI or Firewire® or analog alternatives like RBG. The head unit 106 may decode the image signal and deliver it directly to the screen 114 or it may filter it, for example, by upscaling, downscaling, or cropping the image 604a to accommodate the resolution of the screen 114. The head unit may combine part or all of the image 604a with screen image elements generated by the head unit itself or other accessory devices to generate mixed images.

The image may be provided by the navigation system in several forms including a full image map, difference data, or vector data. For a full image map, as shown in FIG. 6A, each frame 604a-604d of image data contains a complete image. For difference data, as shown in FIG. 6B, a first frame 606a includes a complete image, and subsequent frames 606b-606d only indicate changes to the first frame 606a (note moving indicator 314 and changing directions 316). A complete frame 606a may be sent periodically, as is done in known compression methods, such as MPEG. Vector data, as shown in FIG. 6C, provides a set of instructions that tell the processor 120 how to draw the image, e.g., instead of a set of points to draw the line 318, vector data includes an identification 608 of the end points of segments 612 of the line 318 and an instruction 610 to draw a line between them.

The image may also be transmitted as bitmap data, as shown in FIG. 6D. In this example, the head unit 106 maintains a library 622 of images 620 and the navigation system 104 provides instructions of which images to use to form the desired display image. Storing the images 620 in the head unit 106 allows the navigation system 104 to simply specify 621 which elements to display. This can allow the navigation system 104 to communicate the images it wishes the head unit 106 to display using less bandwidth than may be required for a full video image. Storing the images 620 in the head unit 106 may also allow the maker of the head unit to dictate the appearance of the display, for example, by maintaining a branded look-and-feel different from that used by the navigation system 104 on its built-in interface 124. The pre-arranged image elements 620 may include icons like the vehicle location icon 314, driving direction symbols 624, or standard map elements 626 such as straight road segments 626a, curves 626b, and intersections 626c, 626d. Using such a library of image elements may require some coordination between the maker of the navigation system 104 and the maker of the head unit 106 in the case where the manufacturers are different, but could be standardized to allow interoperability. Such a technique may also be used with the audio navigation prompts discussed above—pre-recorded messages such as “turn left in 100 yards” may be stored in the head unit 106 and selected for playback by the navigation system 104.

In a similar fashion, as shown in FIG. 6E, the individual screen elements 620 may be transmitted from the navigation system 104 with instructions 630 on how they may be combined. In this case, the elements may include specific versions such as actual maps 312 and specific directions 316, such as street names and distance indications, that would be less likely to be stored in a standardized library 622 in the head unit 106. Either approach may simplify generating mixed-mode screen images, like screen images 320 and 330, that contain graphical elements of both the entertainment system 102 and the navigation system 104, because the head unit 106 does not have to analyze a full image 602 to determine which portion to display.

When an image is being transmitted from the navigation system 104 to the head unit 106, the amount of bandwidth required may dominate the connections between the devices. For example, if a single USB connection is used for the video signals 220, audio signals 222, and commands and information 224, a full video stream may not leave any room for control data. In some examples, as shown in FIG. 6F, this can be addressed by dividing the video signals 220 into blocks 220a, 220b, . . . 220n and interleaving blocks of commands and information 224 in between them. This can allow high priority data like control inputs to generate interrupts that assure they get through. Special headers 642 and footers 644 may be added to the video blocks 220a-220n to indicate the start or end of frames, sequences of frames, or full transmissions. Other approaches may also be used to transmit simultaneous video, audio, and data, depending on the medium used.

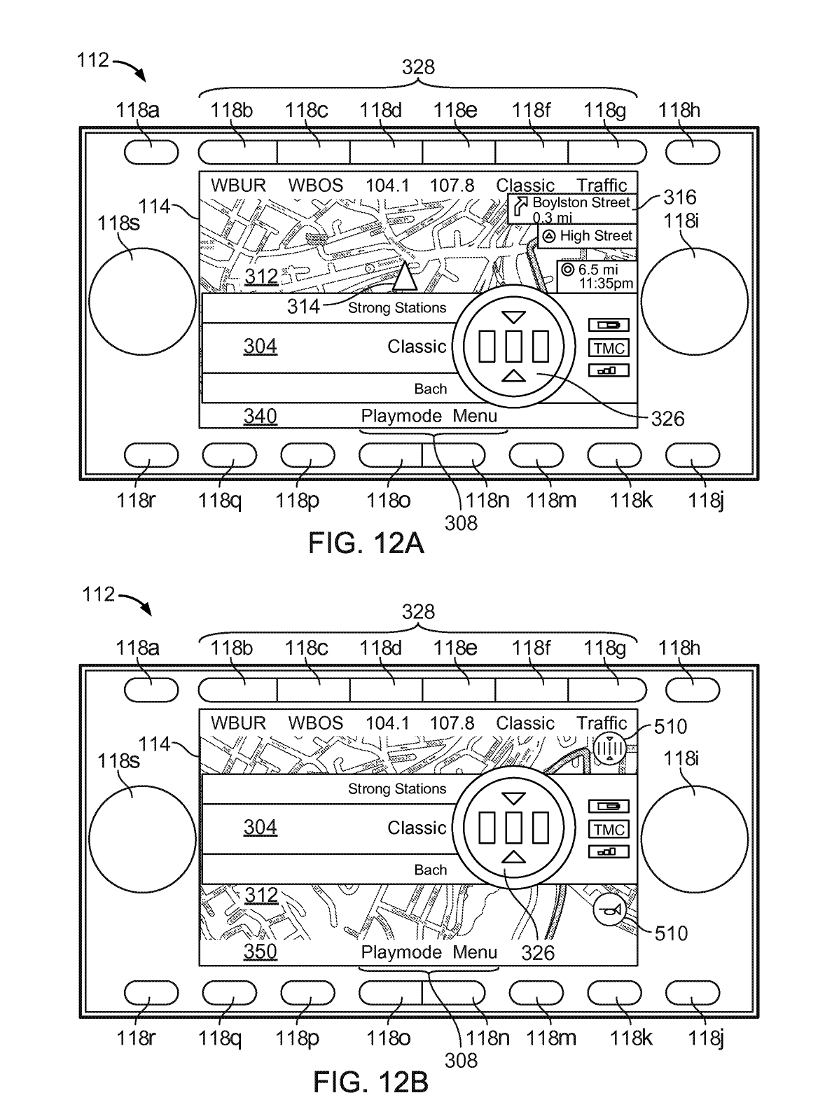

In some examples, visual elements relating to different functions may be displayed simultaneously in overlapping layers. FIGS. 12A-B depict examples of the user interface 112 displaying visual elements pertaining to the navigation function performed by the portable navigation system 104 on the screen 114 in one layer and displaying visual elements pertaining to entertainment in an overlying layer. This layering of visual elements pertaining to entertainment over visual elements pertaining to navigation enables the relative prominence of the visual elements of each of these two functions to be quickly changed as will be explained. The portable navigation system 104 and the head unit 106 interact in a manner that causes visual elements provided by the portable navigation system 104 to be displayed on the screen 114 through the user interface 112, and a user of the head unit 106 is able to interact with the navigation function of the navigation system 104 through the user interface 112. Visual elements pertaining to entertainment are also displayed on the screen 114 through the user interface 112, and the user is also able to interact with the entertainment function through the user interface 112.

As shown in FIG. 12A, the screen 114 shows an image 340 combining aspects of both navigation and entertainment functions. The navigation portion of the image 340 is at least partially made up of a map 312 that may be accompanied with a location indicator 314 and/or a next step of directions 316. The entertainment portion of the image 340 is at least partially made up of an identification 304 of a currently playing song and an icon 326 indicating the current radio mode, and these may be accompanied by other information 328 indicating various radio stations selectable by pressing buttons 118b-118h and/or other functions 308 selectable through buttons 118n and 1180. As can be seen, in the image 340, the display of the navigation function is intended to be more dominant (e.g., occupying more of the screen 114) than the display of the entertainment function. A considerable amount of the viewable area of the screen 114 is devoted to the map 312, and a relatively minimal portion of the map 312 is overlain by the identification 304 and the icon 326.

FIG. 12B depicts one possible response that may be provided by the user interface 112 to a user of the head unit 106 extending their hand towards the head unit 106. In some embodiments, the head unit 106 incorporates a proximity sensor (not shown) that detects the approach of the user's extended hand. Alternatively, the depicted response could be to an actuation of one of the buttons and knobs 118a-118s by the user. As depicted, this response entails changing the manner in which navigation and entertainment functions are displayed by the user interface 112 such that an image 350 is displayed on the screen 114 in which the display of the entertainment function is made more dominant than the display of the navigation function. By way of example, as depicted in FIG. 12B, the identification 304 and the icon 326 are both enlarged and positioned at a more central location overlying the map 312 on the screen 114 relative to their size and position in FIG. 12A. Furthermore, the next step of directions 316 (FIG. 12A) is removed from view and virtual buttons 510 pertaining to the entertainment function are prominently displayed such that they also overly the map 312. Such dominance of the entertainment function in response to the detection of the proximity of the user's hand could be caused, in one embodiment, to occur based on an assumption that the user is more likely to intend to interact with the entertainment function than the navigation function. In some embodiments, this response is automatically disabled by the occurrence of a condition that is taken to negate the aforementioned assumption, such as the vehicle being put into “park,” based on the assumption that the user is more likely to take that opportunity to specify a new destination. In alternative embodiments, the user may be provided with the ability to disable this response.

Entertainment system 102 may include software that can do more than relay the navigation system's interfaces through the entertainment system. The entertainment system 102 may include software that can generate an integrated user interface, through which both the navigation system and the entertainment system may be controlled. For example, the software may incorporate one or more elements from the graphical user interface of the navigation system into a “native” graphical user interface provided by the entertainment system. The result is a combined user interface that includes familiar icons and functions from the navigation system, and that are presented in a combined interface that has roughly the same look and feel as the entertainment system's interface.

The following describes integrated user interfaces generated by an entertainment system and displayed on the entertainment system. Integrated interfaces, however, may also be generated by the navigation system 104 and displayed on the navigation system. Alternatively, integrated interfaces may be generated by the navigation system and displayed on the vehicle entertainment system, or vice versa,

There are numerous types of navigation systems on the market, each offering different functionalities and different user interfaces. The differences may be in both their graphical user interfaces and their human-machine user interfaces. The content of an integrated interface will depend, to a great extent, on the features available from a particular navigation system. In order to construct a combined interface, in this example, software in the vehicle entertainment system first identifies the type (e.g., brand/model) of navigation system that is connected to the entertainment system. Here, identification is performed via a “handshake” protocol, which may be implemented when the navigation systems and entertainment system are first electrically connected. In this context, an electrical connection may include a wired connection, a wireless connection, or a combination of the two. Identification may also be performed by a user, who provides the type information of the navigation system manually to the vehicle entertainment system.

During the initial handshake protocol, information about the connected navigation system is transmitted to the entertainment system. Such information may be transmitted through communication interfaces between the entertainment system and the navigation system, such as those described above. The transmitted information may include type information, which identifies the type of the navigation system. The type information may be coded in an identifier field of a message having a predefined format. In this example, processor 120 of the entertainment system uses the obtained type information to identify the navigation system, and to generate an integrated user interface based on this identification. The processor 120 can generate graphical portions of the user interface either using pre-stored bitmap data or using data received from the navigation system, as described in more detail below.

Each type of device may have a user interface functional hierarchy. That is, each device has certain capabilities or functions. In order to access these, a user interacts with the device's human-machine interface. The designers of each navigation system have chosen a way to organize navigation system functions for presentation to, and interaction with, a user. These navigation system functions are associated with corresponding icons. The entertainment system has its own way of organizing its functions for presentation to, and interaction with, a user. The functions of the navigation system may be integrated into the entertainment system in a way that is consistent with how the entertainment system organizes its other functions, but also in a way that takes advantage of the fact that a user of the navigation system will be familiar with graphics that are typically displayed on the navigation system.

Because the human-machine interface of the entertainment system may be different from that of the navigation system, the organizational structure of navigation functions may be modified when integrated into the entertainment system. Some aspects, and not others, may be modified, depending on what is logical, and on what provides a beneficial overall experience for the user. It is possible to determine, in advance, how to change this organization, and to store that data within the entertainment system, so that when the entertainment system detects a navigation system and determines what type of system it is, the entertainment system will know how to perform the organizational mapping. This process may be automated.

By way of example, it may be determined that a high level menu, which has five icons visible on a navigation system, makes sense when integrated with the entertainment system. Software in the entertainment system may obtain those icons and display them on a menu bar so that the same five icons are visible. In some examples, the case may be that the human-machine interfaces for choosing the function associated with an icon are different (e.g., a rotary control vs. a touch screen), but the menu hierarchies for the organization of functions are the same. However, at a different place in the navigation system menu structure, it may be determined that the logical arrangement of available functions provided by the navigation system is not consistent with a logical approach of the entertainment system and, therefore, the entertainment system may organize the functions differently. For example, the entertainment system could decide that one function provided is not needed or desired, and simply not present that function. Alternatively, the entertainment system may decide that a function more logically belongs at a different point in its hierarchy, and move that function to a different point in the vehicle entertainment system user interface organization structure. The entertainment system could decide to remove whole levels of a hierarchy, and promote all of the lower level functions to a higher level. The point is, the organizational structure of the navigation system can be remapped to fit the organizational structure of the entertainment system in any manner. This is done so that, whether the user is interacting with the navigation system, phone, HVAC, audio system, or the like, the organization of functions throughout those systems is presented in as consistent a fashion as possible.

To help reduce confusion when a user switches between use of the navigation system on its own and use within the vehicle, the entertainment system uses the graphics that are associated with particular functions in the navigation system and associates them with the same functions when controlled by the entertainment system user interface.

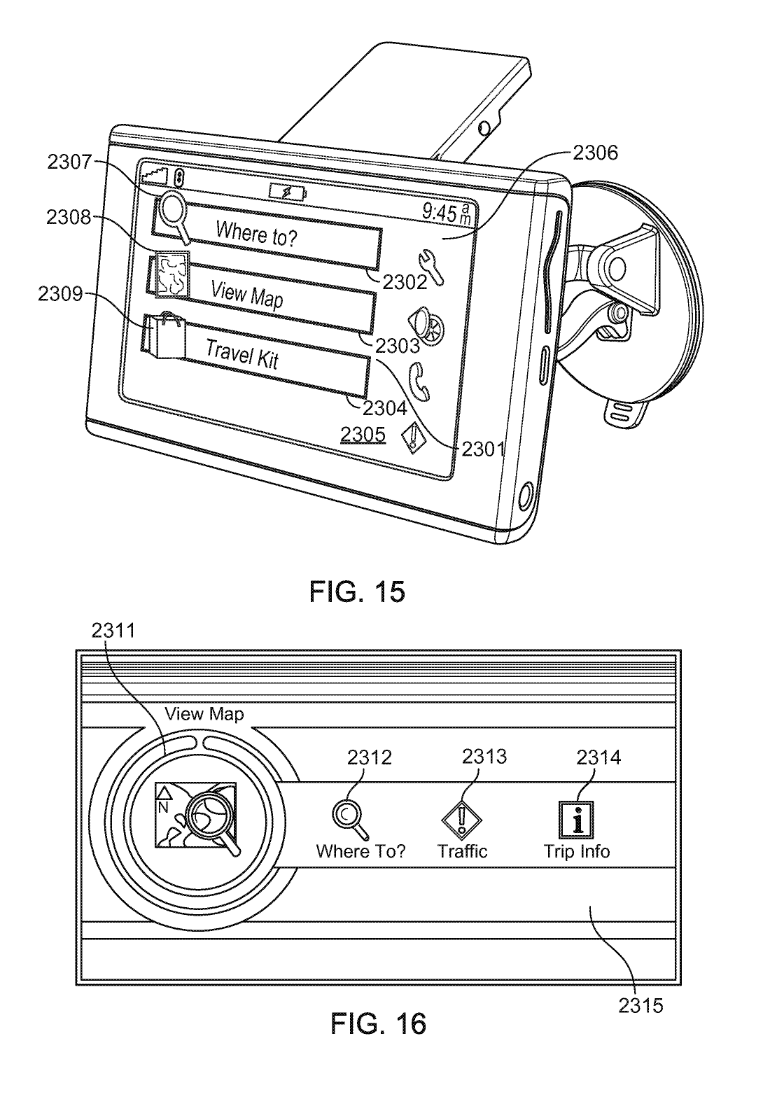

FIG. 15 is an example of a graphical user interface for a first type of navigation system, which contains elements that may be integrated into a native user interface of the entertainment system. This user interface includes a main navigation menu 2301. The main navigation menu 2301 contains three main navigation menu items, “Where to?” 2302, “View Map” 2303, and “Travel Kit” 2304. These menu items can be used to invoke various functions available from the navigation system, such as mapping out a route to a destination. In this example, each menu item is associated with an icon. As stated above, an icon is a graphic symbol associated with a menu item or a functionality. For example, menu item 2302—the “Where to” function—is associated with a magnifying glass icon, 2307. Menu item 2303—the “View Map” function—is associated with a map icon, 2308. Menu item 2304—the “Travel Kit” function—is associated with a suitcase icon, 2309.

The main navigation menu 2301 also contains a side menu 2306, which includes various menu items, in this case: settings, quick settings, phone, and traffic. The functions associated with these menu items, which relate, e.g., to initiating a phone call or retrieving setting information, are also associated with corresponding icons, as shown in FIG. 15. For example, the function of retrieving traffic information is associated with an icon 2305, which is a shaded diamond with an exclamation mark inside.

Navigation system icons 2307, 2308, and 2309 are menu items that are at a same hierarchical level. More specifically, the menu items are part of a hierarchical menu, which may be traversed by selecting a menu item at the top of the hierarchy, and drilling-down to menu items that reside below.

FIG. 16 shows an integrated main menu 2315, which may be generated by software in entertainment system 102 and displayed on display screen 114. This main navigation menu may be accessed by pressing the navigation source button 2375 shown in FIG. 19. The main navigation menu is generated by integrating icons 2311, 2312, 2313, and 2314 associated with the navigation system into an underlying native user interface associated with the entertainment system. The “native” user interface may include, e.g., display features, such as frames, bars, or the like having a particular color, such as orange. The same bitmap data or scaled bitmap data of the icons may be used because the images defined by such data represent icons that are familiar to a user of the navigation system, even though these icons are displayed on the entertainment system and in a format that is consistent with the entertainment system. As a result, the user need not learn a new set of icons, but rather can use the navigation system through the entertainment system using familiar icons. When an icon is active (ready for selection by the user), it may be enlarged to differentiate it from other selections, as shown by the enlarged icon 2311 as compared to the size of 2312, 2313, and 2314. In addition, the icon may be highlighted by a circle to further differentiate it from other selections as shown in FIG. 16.

In FIG. 16, icon 2312, which is the same as icon 2307 in FIG. 15, is associated with “Where to” functionality. Icon 2313, which is the same as icon 2305 in FIG. 15, is associated with “Traffic” control functionality of the navigation system. Icon 2314, which does not have a corresponding icon in FIG. 15, is associated with “Trip Info” functionality. Icon 2311, which is the same as icon 2308, is associated with “View Map”. These icons, along with their associated character strings, may be retrieved by the entertainment system from the navigation system after the navigation system is connected to the entertainment system, and then stored as bitmap data in a storage device of the entertainment system or in other memory that is accessible thereto. Alternatively the icons and other data (e.g., character strings) may be transmitted to the entertainment system when the navigation system is connected to the entertainment system. In another alternative, the icons may be pre-stored in the entertainment system and retrieved for display when the type of the navigation system is identified. For example, upon connecting to the vehicle's entertainment system, the navigation system may transmit its identity to the entertainment system as part of the handshake protocol between the entertainment system and the navigation system. Upon receiving the identity of the navigation system, software in the entertainment system may access a storage device and retrieve the pre-stored icon data associated with the identified navigation system. The software incorporates these icons and associated functionalities into the entertainment system's native user interface, thereby generating a combined interface that includes icons that are familiar to the navigation system user.

In the combined interface of FIG. 16, the icons from the navigation system may be rearranged and populated into a different hierarchical structure on the entertainment system, as shown. For example, side menu bar 2306 in FIG. 15 is not present in FIG. 16. But, icon 2305 on the side menu bar 2306 is presented in FIG. 16, along with icons 2307 and 2308. Icon 2309 is not mapped into FIG. 16. In FIG. 16, icon 2312 (icon 2307 in FIG. 15) is at the same hierarchical level as icon 2313 (icon 2305 in FIG. 15). A user may scroll through these icons to select an icon by either consecutively pressing the navigation source button 2375 shown in FIG. 19 or by rotating the inner knob of a physical dual concentric knob 2381 shown in FIG. 19, and thus invoke a function associated with that icon, e.g., for display of a map on the entertainment system's display device by pressing the dual concentric knob 2381 shown in FIG. 19 or by expiration of a time-out associated with that main navigation menu 2315.

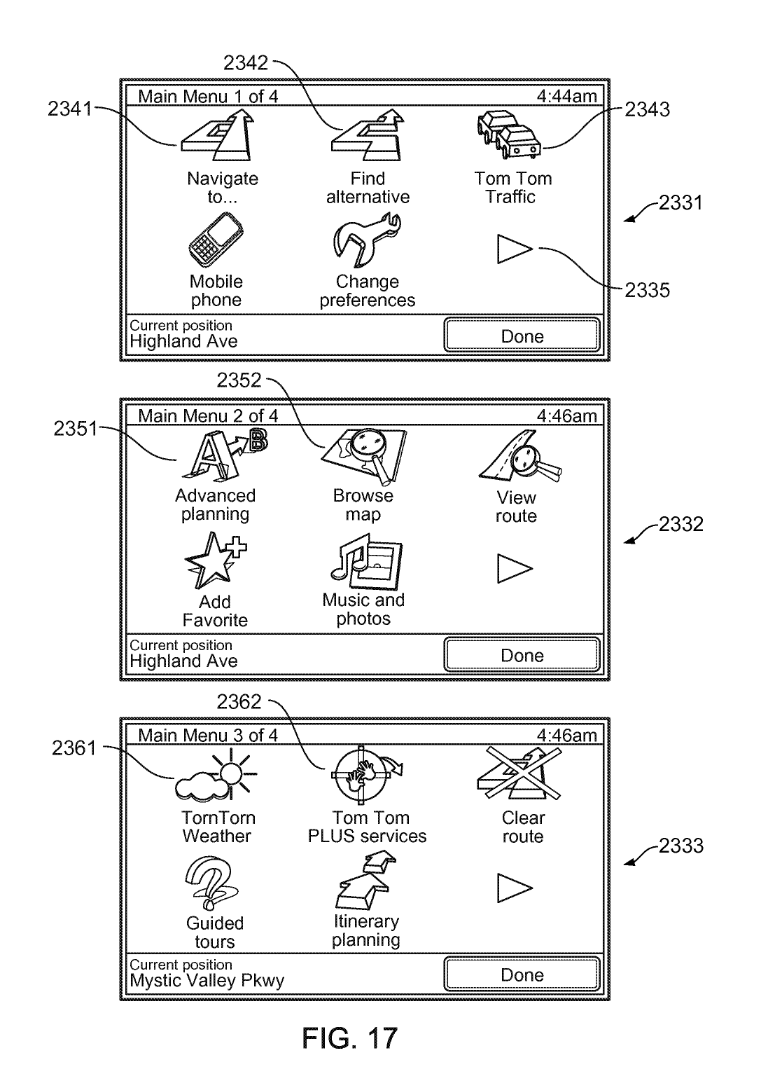

FIG. 17 shows screens of graphical user interfaces for a second type of navigation system, which is different from the navigation system shown in FIGS. 15 and 16. User interface screens 2331, 2332, and 2333 are components of a single main menu, and may be viewed by scrolling from screen-to-screen by selecting an arrow 2335. The main menu includes menu items such as, “Navigate to” 2341, “Find Alternative” 2342, “Traffic” 2343, “Advanced planning” 2351, “Browse map” 2352, “Weather” 2361, and “Plus services” 2362. Each menu item corresponds to a functionality that is available from the navigation system. For example, “Navigate to” provides directions to a particular location, “Traffic” provides traffic information, and “Weather” provides weather information for a particular location. As was the case above, each menu item from user interface screens 2331, 2332, and 2333 is represented by a corresponding icon that is unique to that menu item. The menu items also may be hierarchical in that a user may drill down to reach other menu items represented by other icons (not shown).

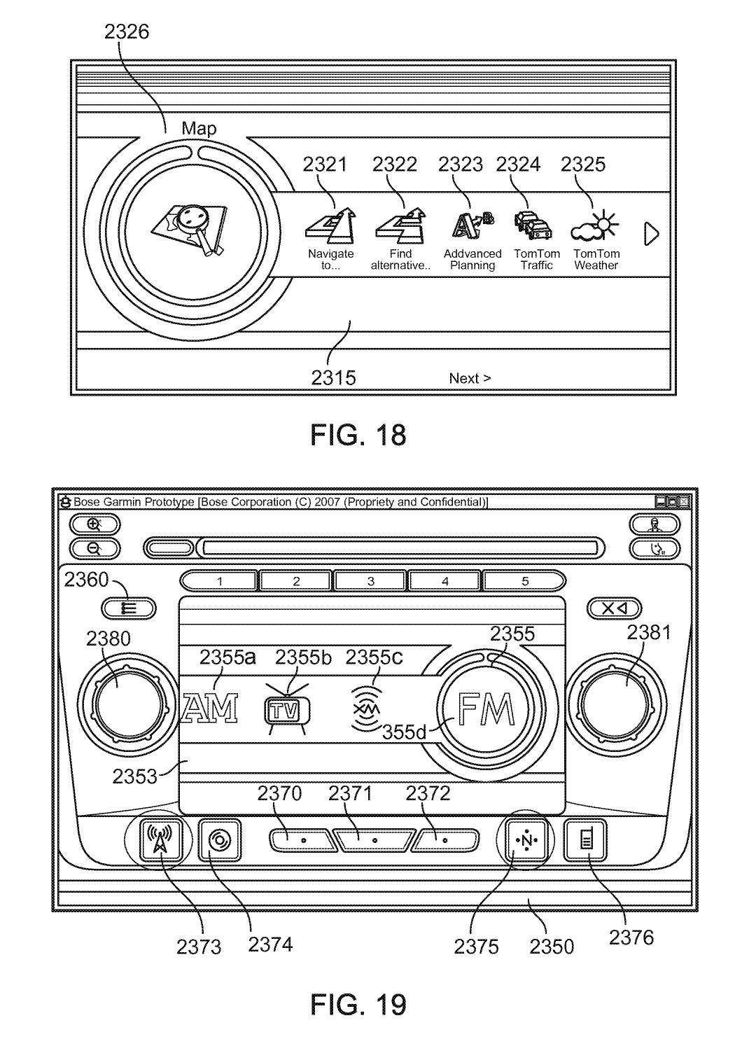

The menu items of FIG. 17 may be integrated into the native user interface of the entertainment system, as was described above with respect to FIG. 16. FIG. 18 shows another version of an integrated main navigation menu 2315, which may be generated by software in entertainment system 102 and displayed on display screen 114. The main menu is generated by integrating icons associated with the navigation system of FIG. 17 (e.g., 2341, 2342, 2343, etc.), and their corresponding functionality, into the underlying native user interface associated with the entertainment system. As was the case above, the “native” user interface may include display features associated with the native user interface of the entertainment system. The icons from the navigation system of FIG. 17 may be mapped to the graphical user interface of FIG. 18 in the manner described above.

When mapping icons from the navigation system user interface screen shown in FIG. 17 to the entertainment (integrated) user interface screen shown in FIG. 18, some icons may be removed. For example, icon “Plus services” 2362, is absent from FIG. 18. The sequence of the icons may also be altered. For example, icon “Advanced planning” 2323 is adjacent to icon “Find alternative” 2322 in FIG. 18, while in FIG. 17 icon “Advanced planning” 2351 is not adjacent to icon “Find alternative” 2342. As described above, icons are mapped from the navigation system to the entertainment system. For example, the “Map” icon 2326 is the same icon as icon 2352 in FIG. 17 which associated with “Browse Map” functionality. Icon 2321, which is the same as icon 2341 in FIG. 17, is associated with the “Navigate to” control functionality of the navigation system. Icon 2322, which is the same as icon 2342 in FIG. 17, is associated with the “Find Alternative” control functionality of the navigation system. Icon 2323, which is the same as icon 2351 in FIG. 17, is associated with the “Advanced Planning” control functionality of the navigation system. Icon 2324, which is the same as icon 2343 in FIG. 17, is associated with the “Traffic” functionality of the navigation system. Icon 2325, which is the same as icon 2361 in FIG. 17, is associated with the “Weather” functionality of the navigation system. As described prior, when an icon is active (ready for selection by the user), it may be enlarged to differentiate it from other selections, as shown by the enlarged icon 2326 as compared to the size of 2321, 2322, 2323, 2324 and 2325. In addition, the icon may be highlighted by a circle to further differentiate it from other selections as shown in FIG. 18.

FIG. 19 shows an exemplary human-machine user interface screen 2350 for the entertainment system. In this example, the human-machine user interface screen includes, among other things, two physical dual concentric knobs 2380 and 2381. FIG. 19 also shows a graphical user interface screen 2353 that contains menu bar 2355. Menu bar 2355 contains icons associated with audio sources AM 2355a, TV 2355b, XM 2355c and FM 2355d. In FIG. 19, the graphical user interface screen 2353 is displaying a main broadcasted media menu as opposed to the integrated main navigation menu 2315. As described above, the main navigation menu may be accessed by pressing the navigation source button 2375. Similarly, the main broadcasted media menu may be accessed by pressing the broadcasted media source button 2373. Similarly, the main stored media menu (not shown) may be accessed by pressing the stored media source button 2374. Similarly, the main phone menu (not shown) may be accessed by pressing the phone source button 2376.

As explained above, the human-machine interface refers to the physical interface between the human operating a system and the device functionality. In this context, the navigation system human-machine interface has one set of controls. Most navigation system human-machine interfaces are touch screens, although they may also have buttons, microphones (for voice input), or other controls. The vehicle entertainment system also has a human-machine interface with a second set of controls. The controls of the vehicle system may be the same as, similar to, or different than those of the navigation system.

Mapping the human-machine interfaces may be conceptualized using a Venn diagram with two circles. One circle represents the set of human-machine interface controls for the navigation system, and one circle represents the set of controls for the vehicle system. The circles can either be completely separated, have a region of intersection, or be completely overlapping. The sizes of the circles can differ depending on the number of controls of each system. Within the circles, there are a number of discrete points representing each control that is available. What is done in the system described herein is to map one set of controls to another on a context-sensitive basis. For example, in certain system states, a series of icons on a touch screen may be mapped to a series of circles with associated icons that can be scrolled through by rotating one of the concentric knobs. For example, in block 2421 in FIG. 22, a user can rotate a concentric knob to scroll through icons 2430, 2431, 2432, 2433, and 2434. In other system states, icons on a touch screen may be mapped to a different control, such as a programmable button (the function of the button can change with system state). In another example, settings icon 2306 on the touch screen of the navigation device shown in FIG. 15 may be mapped to programmable physical button 2360 on FIG. 19. When the entertainment system is configured to control the navigation system, pressing button 2360 will bring up a settings menu associated with the navigation system. When the entertainment system is configured to control some other system, such as the music library, pressing button 2360 will bring up an options menu associated with the music library function.

The fact that there are different controls can be beneficial. For example, referring to a user interface screen 2331 of FIG. 17, there are five icons shown, plus an arrow. Touching the arrow causes additional icons to show. All of the icons in successive screens 2331, 2332, and 2333 are at the same hierarchal level, but the size of the screen limits the number that is visible at any one time. The navigation system human-machine interface requires a user to touch the screen on the arrow to show different screens with different sets of icons. In many states of the entertainment system, this navigation function is mapped to a rotary knob associated with the entertainment system's human-machine interface. Rotating the knob causes a set of circles arranged in a semi circle (e.g., FIG. 22) to rotate clockwise or counter clockwise as the rotary control is rotated. Each circle corresponds to one of the icons on the touch screen. In this case, an icon is selected by rotating the control until the desired icon is centered on the display (sometimes the rotary knob needs to be pushed to select the function associated with the icon, sometimes not, depending on the system state). However, the rotating circle can have an arbitrary number of icons that that can be scrolled. Only five circles at a time are shown in the example of FIG. 22, but rotation of the knob allows one to scroll through all of the icon choices at this hierarchy level, without having to go to a new screen. The rotary knob enables the user to easily scroll through a larger number of icons (that represent functions the navigation system can perform) than one can interact with on a small touch screen.

In some cases, it has been determined that certain functions should be associated with a button (a soft button or a programmable function button), rather than one of the circle elements that a rotary control scrolls through. For example, the “settings” function represented by the wrench icon of FIG. 15 may be mapped to button 2360 shown on FIG. 19. Button 2360 is the “options” button. It brings up settings in various system states (e.g., settings for the CD player, FM, phone, etc. depending on which state the system is in).

Some aspects of the organizational structure of the human-machine user interface elements may be altered so as to provide a better overall experience for the user. In some examples, the menu structure of a navigation system may be logically inconsistent with the corresponding menu structure of the entertainment system. The hierarchical structure of the navigation system may be re-organized. The relative level associated with a menu item may be changed. A lower level menu item may be moved to a higher level, or vice versa.

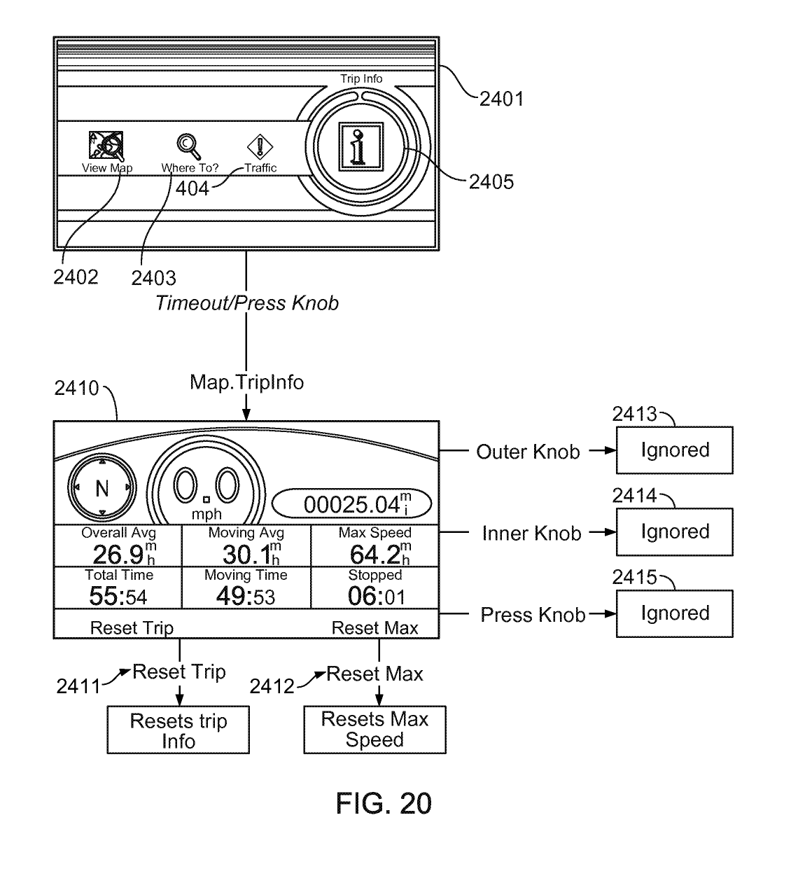

FIG. 20 is a user interface flow chart, which depicts an operation of the integrated user interface containing elements of both the navigation system and the entertainment system. In FIG. 20, a screen 2401 shows a different icon selection highlighted 2405 within the main navigation menu 2315. The icons 2402, 2403, 2404, and 2405 are the same icons 2311, 2312, 2313, and 2314 of FIG. 16. However, in FIG. 20, trip info icon 2405 is highlighted and is enlarged indicating that the icon is active for selection as previously described. When a user selects icon 2402, 2403, 2404, or 2405, software in the entertainment system takes the user to the next level under the navigation main menu. In FIG. 20, when a user presses the concentric knob to select trip info soft functionality or when a user scrolls through the main menu and highlights the trip info soft functionality without pressing the concentric knob, the system times out and selects the trip info soft functionality, and the software provides a next level of navigation functionality, namely “trip info” display view 2410. In “trip info” display view 2410, two navigational features of the navigation system—reset trip 2411 and reset max 2412—are mapped to two programmable buttons of an array of three programmable buttons 2370, 2371, and 2372 that are lined along the bottom (or top) of the entertainment system display.

In some examples, menu items associated with navigational features may be mapped onto a concentric knob provided on the entertainment system. Generally, the outer knob and the inner knob of a concentric knob are associated with different levels of a hierarchy. For example, a concentric knob may be configured to move to a previous/next item when the outer knob is turned, to display a scroll list when the inner knob is turned, and to actuate a control functionality when the knob is pressed. When the system is at the navigation level of the “trip info” display view, shown as 2410 in FIG. 20, the physical concentric knobs, 2380 and 2381, have no functions mapped to them, shown by the “ignored” boxes 2413, 2414, and 2415.

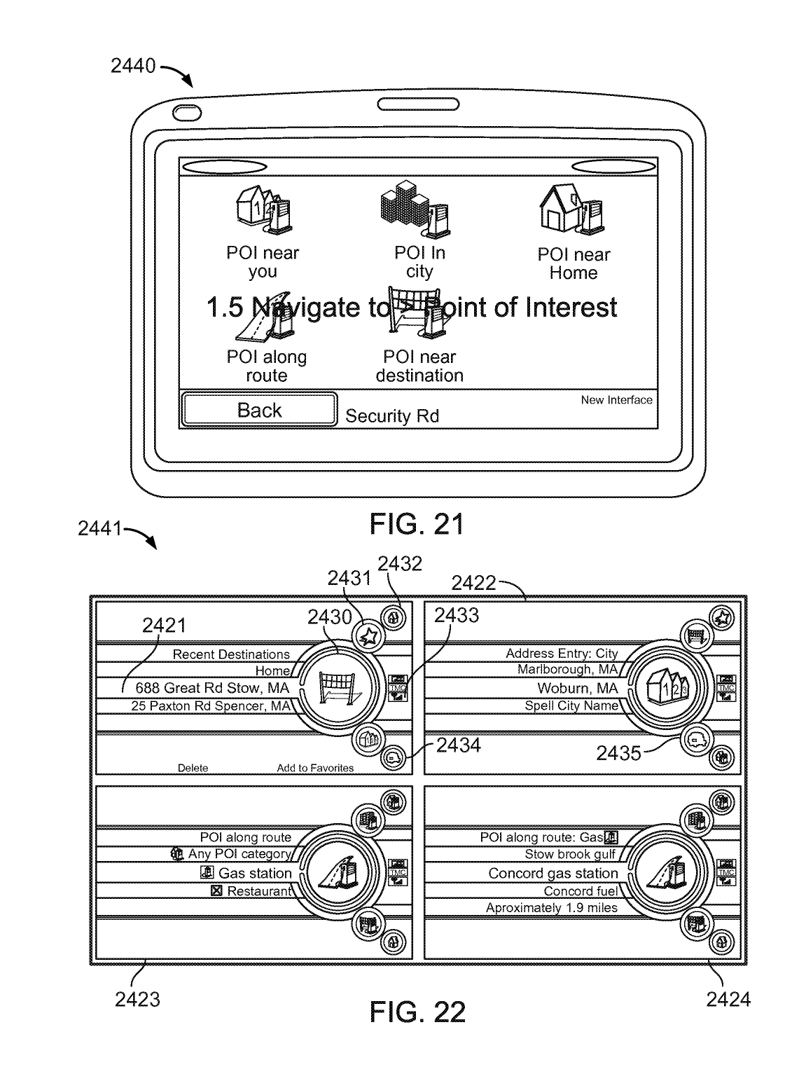

FIG. 21 shows a pre-integration user interface and FIG. 22 shows a corresponding integrated user interface associated with a navigation system. Screen 2440 shows the user interface of the navigation system before it has been mapped into the entertainment system user interface 2441. In user interface screen 2441, four example screens 2421, 2422, 2423, and 2424 are presented. User interface screen 2421 shows recent destinations. These menu items can be scrolled though using the inner rotary knob of knob 2381 (FIG. 19) and can be selected when knob 2381 is pressed or a time-out is exceeded. When the user selects menu item 2433 by rotating the outer rotary knob of knob 2381, the user is brought to user interface screen 2422. User interface screen 2422 allows a user to find a place of interest via an address entry. User interface screen 2422 also allows a user to spell out the name of the city if the city name is not contained in the list. When a user rotates the outer rotary knob of knob 2381 to select menu item 2435, the user is taken to user interface screen 2423. User interface screen 2423 allows a user to search through categories of point of interest (POI) along route. The categories of POI along a route may include gas stations, restaurants, and the like. If a user selects the gas station category by pressing the dual concentric knob 2381, the user is taken to user interface screen 2424. User interface screen 2424 allows a user to scroll to a specific gas station by rotating the inner rotary knob of knob 2381 and to enter a selection by pressing the dual concentric knob 2381. These user interface screens retain the same graphical characteristics of the entertainment system, but they contain icons used in the navigation system.

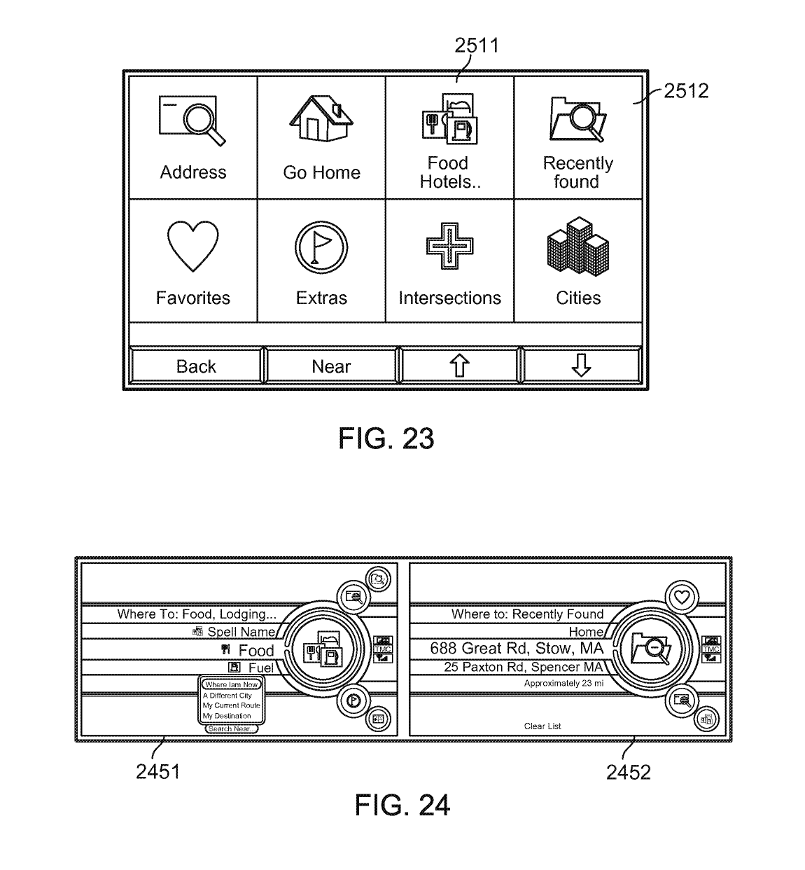

FIG. 23 shows a screen shot of a graphic user interface for a navigation system that is different from the navigation system depicted in FIG. 21. The user interface screen shown in FIG. 23 allows a user to select destination categories, such as “Food, Hotels” as represented by menu item 2511, or “Recently found” as represented by menu item 2512. This user interface screen is shown after the “Where to” icon 2302 is selected by pressing the touch screen when in the top level menu 2301 shown in FIG. 15.

FIG. 24 shows an integrated user interface for the entertainment system that is presented when the “Where to” icon 2312 in FIG. 16 has been selected. In this instance, the “Where to” functionality of the navigation system as shown in FIG. 23 is mapped to the integrated user interface of FIG. 24. The function associated with the menu item 2511 is remapped into user interface screen 2451. The function associated with the menu item 2512 is remapped into user interface screen 2452. Because the entertainment system is connected to a different navigation system in this example than in FIG. 22, the icons, navigational functions, and the character strings differ from those shown in FIG. 22. As was the case above, the icons and the character strings retain their characteristics from the navigation system, but are incorporated into the entertainment system's interface to produce a combined user interface.

In the user interfaces described above that include layering, either a hardware-based or a software-based implementation of layering may be used. In a software-based implementation, the processor 120 (FIG. 1B), is caused by software implementing the user interface 112 to perform layering by providing only portions of the visual elements pertaining to the navigation function that are not overlain by portions of the visual elements pertaining to the entertainment function to be displayed on the screen 114, and causing visual elements pertaining to the entertainment function to be displayed in their overlying locations on the screen 114. Alternatively, a graphics processing unit (not shown) of the head unit 106 may perform at least part of this layering in lieu of the processor 120. In a hardware-based implementation, a pixel-for-pixel hardware map of which layer is to be displayed at each pixel of the screen 114 may be employed, and at least one visual element pertaining to entertainment may be stored in a dedicated storage device (not shown), such as a hardware-based sprite. As bitmaps, vector scripts, color mappings and/or other forms of data pertaining to the appearance of one or more of visual elements of the navigation function are received by the head unit 106 from the portable navigation system 104, various indexing and/or addressing algorithms may be employed to cause visual elements pertaining to the navigation function to be stored separately or differently from the visual elements pertaining to the entertainment function.

Differences in how a given piece of data is displayed on the screen 174 and how it is displayed on the screen 114 may dictate whether that piece of data is transmitted by the portable navigation system 104 to the head unit 106 as visual data or as some other form of data, and may dictate the form of visual data used where the given piece of data is transmitted as visual data. By way of example and solely for purposes of discussion, when the portable navigation system 104 is used by itself and separately from the head unit 106, the portable navigation system 104 may display the current time on the screen 174 of the portable navigation system 104 as part of performing its navigation function. However, when the portable navigation system 104 is then used in conjunction with the head unit 106 as has been described herein, the portable navigation system 104 may transmit the current time to the head unit 106 to be displayed on the screen 114. This transmission of the current time may be performed either by transmitting the current time as one or more values representing the current time, or by transmitting a visual element that provides a visual representation of the current time such as a bitmap of human-readable digits or an analog clock face with hour and minute hands.

In some embodiments, where the screen 114 is larger or in some other way superior to the screen 174, what is displayed on the screen 114 may differ from what would be displayed on the screen 174 in order to make use of the superior features of the screen 114. In some cases, even though the current time may be displayed on the screen 174 as part of a larger bitmap of other navigation input data, it may be desirable to remove that display of the current time from that bitmap, and instead, transmit the time as one or more numerical or other values that represent the current time to allow the head unit 106 to display that bitmap without the inclusion of the current time. This would also allow the head unit 106 to either employ those value(s) representing the current time in generating a display of the current time that is in some way different from that provided by the portable navigation unit 104, or would allow the head unit to refrain from displaying the current time, altogether. Alternatively, it may be advantageous to simply transfer a visual element providing a visual representation of the current time as it would otherwise be displayed on the screen 174 for display on the screen 114, but separate from other visual elements to allow flexibility in positioning the display of the current time on the screen 114. Those skilled in the art will readily recognize that although this discussion has centered on displaying the current time, it is meant as an example, and this same choice of whether to convey a piece of data as a visual representation or as one or more values representing the data may be made regarding any of numerous other pieces of information provided by the portable navigation device 104 to the head unit 106.

As previously discussed with regard to FIGS. 3A-D and 15-24, the various buttons and knobs 118a-s may be used as a proxy for buttons or knobs of the portable navigation system 104 and/or for virtual controls displayed as part of the touchscreen functionality provided by the screen 174 and the touchscreen sensor 176 of the portable navigation system 104. Given that one or more of the buttons and knobs 118a-s may be used as a proxy in place of one or more virtual controls displayed on the screen 174, it may be desirable to remove the image of such controls from one or more images transmitted from the portable navigation device 104 to the head unit 106. It is further possible that the determination of which control of the portable navigation system 104 is to be replaced by which of the buttons and knobs 118a-s as a proxy may be made dynamically in response to changing conditions. For example, it is possible that the portable navigation system 104 may be used with two or different versions of the head unit 106 (e.g., a user with more than one vehicle having a version of the head unit 106 installed therein) where one of the two versions provides one or more buttons or knobs that the other version does not. The version with the greater quantity of buttons or knobs would enable more of the controls of the portable navigation system 104 to be replaced with buttons or knobs in a proxy role than the other version. When the portable navigation system 104 is used with the other version, more of the controls may have to be presented to the user as virtual controls on the screen 114.

In some examples, the entertainment system 102 can support more than one portable navigation system. For example, a user may disconnect the first navigation system connected to the entertainment system 102 and connect a different portable navigation system. The entertainment system may be able to generate a second integrated user interface using the elements of the user interface of the second portable navigation system and control the second portable navigation system through the second integrated user interface.

In some examples, the entertainment system 102 can support more than one portable system at the same time (e.g., two portable navigation systems, a portable navigation system and an MP3 player, a portable navigation system and a mobile telephone, a portable navigation system and a personal digital assistant (PDA), an MP3 player and a PDA, or any combination of these or other devices). In this case, the entertainment system 102 may be able to integrate elements of (e.g., all or part of) the user interfaces of two (or more) such devices into its own user interface in the manner described herein. The entertainment system 102 may generate a combined user interface to control the portable navigation system and the other device(s) at the same time in the manner described herein.

Audio from the navigation system 104 and entertainment system 102 may also be integrated into the entertainment system. The navigation system may generate audio signals, such as a voice prompt telling the driver about an upcoming turn, which are communicated to the entertainment system 102 through audio signals 222 as described above. At the same time, the entertainment system 102 may generate continuous audio signals, such as music from the radio or a CD. In some examples, a mixer in the head unit 106 determines which audio source takes priority, and directs the prioritized audio signals to speakers 226, e.g., to a particular speaker. A mixer may be a combiner that sums audio signals to form a combined signal. The mixer may also control the level of each signal that is summed. When a navigation voice prompt comes in, the audio signals can be routed in different ways with their levels adjusted so that the navigation voice prompt will be more audible to vehicle occupants.

As indicated above, a mixer has the capability of directing a signal to a specific speaker. For example, when a turn is coming up, and the navigation system 104 sends an announcement via audio signals 222 (see FIG. 2), the mixer may reduce the volume of music and play the turn instructions at a relatively loud volume. If the entertainment system is receiving vehicle information 203, it may also base the volume of the entertainment system on factors that may affect ambient noise, e.g., increasing the volume to overcome road noise based on the vehicle speed 208, or ambient noise directly sensed within the vehicle. In some examples, the entertainment system may include a microphone to directly discover noise levels and to compensate for those noise levels by raising the volume, adjusting the frequency response of the system, or both. The audio from the lower-priority source may be silenced completely or may only be reduced in volume and mixed with the louder high-priority audio. The mixer may be an actual hardware component or may be a function carried out by the processor 120. The entertainment system may have the capability of determining the ambient noise present in the vehicle, and adjusting its operation to compensate for the noise. It can also apply this compensation to the audio signal received from the navigation system to ensure that the audio from the navigation system is always audible, regardless of the noise levels present in the vehicle.

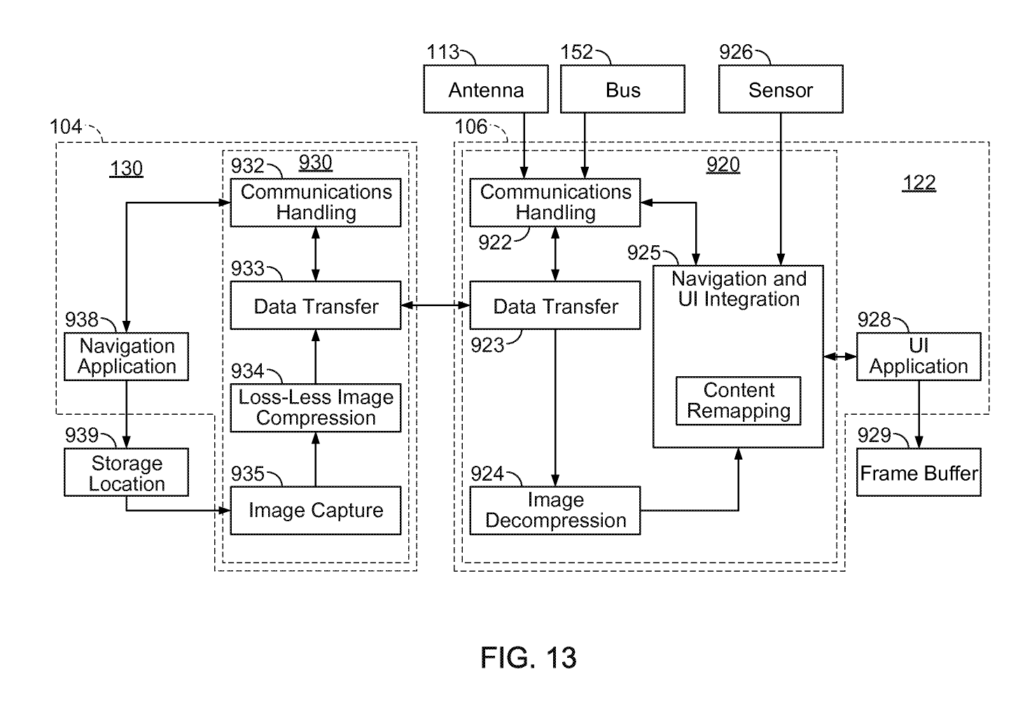

FIG. 13 depicts one possible implementation of software-based interaction between the navigation system 104 and the head unit 106 that allows images made up of visual elements provided by the navigation system 104 to be displayed on the screen 114, and that allows a user of the head unit 106 to interact with the navigation function of the navigation system 104. The display of images and the interactions that may be supported by this possible implementation may include those discussed with regard to any of FIGS. 3A-D, 6A-F, 12A-B, 16, 18, 19, 20, 22, and 24.

As earlier discussed, the head unit 106 incorporates software 122. A portion of the software 122 of the head unit 106 is a user interface application 928 that causes the processor 120 to provide the user interface 112 through which the user interacts with the head unit 106. Another portion of the software 122 is software 920 that causes the processor 120 to interact with the navigation system 104 to provide the navigation system 104 with vehicle data such as speed data, and to receive visual and other data pertaining to navigation for display on the screen 114 to the user. Software 920 includes a communications handling portion 922, a data transfer portion 923, an image decompression portion 924, and a navigation and user interface (UI) integration portion 925.

As also earlier discussed, the navigation system 104 incorporates software 130. A portion of the software 130 is software 930 that causes the processor 128 to interact with the head unit 106 to receive the navigation input data and to provide visual elements and other data pertaining to navigation to the head unit 106 for display on the screen 114. Another portion of the software 130 of the navigation system 104 is a navigation application 938 that causes the processor 128 to generate those visual elements and other data pertaining to navigation from the navigation input data received from the head unit 106 and data it receives from its own inputs, such as GPS signals. Software 930 includes a communications handling portion 932, a data transfer portion 933, a loss-less image compression portion 934, and an image capture portion 935.

As previously discussed, each of the navigation system 104 and the head unit 106 are able to be operated entirely separately of each other. In some embodiments, the navigation system 104 may not have the software 930 installed and/or the head unit 106 may not have the software 920 installed. In such cases, it would be necessary to install one or both of software 920 and the software 930 to enable the navigation system 104 and the head unit 106 to interact.

In the interactions between the head unit 106 and the navigation system 104 to provide a combined display of imagery for both navigation and entertainment, the processor 120 is caused by the communications handling portion 922 to assemble GPS data received from satellites (perhaps, via the antenna 113 in some embodiments) and/or other location data from vehicle sensors (perhaps, via the bus 152 in some embodiments) to assemble navigation input data for transmission to the navigation system 104. As has been explained earlier, the head unit 106 may transmit what is received from satellites to the navigation system 104 with little or no processing, thereby allowing the navigation system 104 to perform most or all of this processing as part of determining a current location. However, as was also explained earlier, the head unit 106 may perform at least some level of processing on what is received from satellites, and perhaps provide the portable navigation unit 104 with coordinates derived from that processing denoting a current location, thereby freeing the portable navigation unit 104 to perform other navigation-related functions. Therefore, the GPS data assembled by the communications handling portion 922 into navigation input data may have already been processed to some degree by the processor 120, and may be GPS coordinates or may be even more thoroughly processed GPS data. The data transfer portion 923 then causes the processor 120 to transmit the results of this processing to the navigation system 104. Depending on the nature of the connection established between the navigation system and the head unit 106 (i.e., whether that connection is wireless (including the use of either infrared or radio frequencies) or wired, electrical or fiber optic, serial or parallel, a connection shared among still other devices or a point-to-point connection, etc.), the data transfer portion 923 may serialize and/or packetize data, may embed status and/or control protocols, and/or may perform various other functions required by the nature of the connection.

Also in the interactions between the head unit 106 and the navigation system 104, the processor 120 is caused by the navigation and user interface (UI) integration portion 925 to relay control inputs received from the user interface (UI) application 928 as a result of a user actuating controls or taking other actions that necessitate the sending of commands to the navigation system 104. The navigation and UI integration portion relays those control inputs and commands to the communications handling portion 922 to be assembled for passing to the data transfer portion 923 for transmission to the navigation system 104.

The data transfer portion 933 causes the processor 128 to receive the navigation input data and the assembled commands and control inputs transferred to the navigation system 104. The processor 128 may further perform some degree of processing on the received navigation input data and the assembled commands and control inputs. In some embodiments, this processing may be little more than reorganizing the navigation input data and/or the assembled commands and control inputs. Also, in some embodiments, this processing may entail performing a sampling algorithm to extract data occurring at specific time intervals from other data.

The processor 128 is then caused by the navigation application 938 to process the navigation input data and to act on the commands and control inputs. As part of this processing, the navigation application 938 causes the processor 128 to generate visual elements pertaining to navigation and to store those visual elements in a storage location 939 defined within storage 164 (as shown in FIG. 1C) and/or within another storage device of the navigation system 104. In some embodiments, the storage of the visual elements may entail the use of a frame buffer defined through the navigation application 938 in which at least a majority of the visual elements are assembled together in a substantially complete image to be transmitted to the head unit 106. It may be that the navigation application 938 routinely causes the processor 128 to define and use a frame buffer as part of enabling visual navigation elements pertaining to navigation to be combined in the frame buffer for display on the screen 174 of the navigation system 104 when the navigation system 104 is used separately from the head unit 106. It may be that the navigation application continues to cause the processor 128 to define and use a frame buffer when the image created in the frame buffer is to be transmitted to the head unit 106 for display on the screen 114. Those skilled in the art of graphics systems will recognize that such a frame buffer may be referred to as a “virtual” frame buffer as a result of such a frame buffer not being used to drive the screen 174, but instead, being used to drive the more remote screen 114. In alternate embodiments, at least some of the visual elements may be stored and transmitted to the head unit 106 separately from each other. Those skilled in the art of graphics systems will readily appreciate that visual elements may be stored in any of a number of ways.

Where the screen 114 of the head unit 106 is larger or has a greater pixel resolution than the screen 174 of the portable navigation system 104, one or more of the visual elements pertaining to navigation may be displayed on the screen 114 in larger size or with greater detail than would be the case when displayed on the screen 174. For example, where the screen 114 has a higher resolution, the map 312 may be expanded to show more detail, such as streets, when created for display on the screen 114 versus the screen 174. As a result, where a frame buffer is defined and used by the navigation application 938, that frame buffer may be defined to be of a greater resolution when its contents are displayed on the screen 114 than when displayed on the screen 174.

Regardless of how exactly the processor 128 is caused by the navigation application 938 to store visual elements pertaining to navigation, the image capture portion 935 causes the processor 128 to retrieve those visual elements for transmission to the head unit 106. As those skilled in the art of graphics systems will readily recognize, where a repeatedly updated frame buffer is defined and/or where a repeatedly updated visual element is stored as a bitmap (for example, perhaps the map 312), there may be a need to coordinate the retrieval of either of these with their being updated. Undesirable visual artifacts may occur where such updating and retrieval are not coordinated, including instances where either a frame buffer or a bitmap is displayed in a partially updated state. In some embodiments, the updating and retrieval functions caused to occur by the navigation application 938 and the image capture portion 935, respectively, may be coordinated through various known handshaking algorithms involving the setting and monitoring of various flags between the navigation application 938 and the image capture portion 935.

However, in other embodiments, where the navigation application 938 was never written to coordinate with the image capture portion 935, the image capture portion 935 may cause the processor 128 to retrieve a frame buffer or a visual element on a regular basis and to monitor the content of such a frame buffer or visual element for an indication that the content has remained sufficiently unchanged that what was retrieved may be transmitted to the head unit 106. More specifically, the image capture portion 935 may cause the processor 128 to repeatedly retrieve the content of a frame buffer or a visual element and compare every Nth horizontal line (e.g., every 4th horizontal line) with those same lines from the last retrieval to determine if the content of any of those lines has changed, and if not, then to transmit the most recently retrieved content of that frame buffer or visual element to the head unit 106 for display. Such situations may arise where the software 930 is added to the portable navigation system 104 to enable the portable navigation system 104 to interact with the head unit 106, but such an interaction between the portable navigation system 104 and the head unit 106 was never originally contemplated by the purveyors of the portable navigation system 104.

The loss-less image compression portion 934 causes the processor 128 to employ any of a number of possible compression algorithms to reduce the size of what the image capture portion 935 has caused the processor 128 to retrieve in order to reduce the bandwidth requirements for transmission to the head unit 106. This may be necessary where the nature of the connection between the portable navigation system 104 and the head unit 106 is such that bandwidth is too limited to transmit an uncompressed frame buffer and/or a visual element (e.g., a serial connection such as EIA RS-232 or RS-422), and/or where it is anticipated that the connection will be used to transfer a sufficient amount of other data that bandwidth for those transfers must remain available.

Such a limitation in the connection may be addressed through the use of data compression, however, as a result of efforts to minimize costs in the design of typical portable navigation systems, there may not be sufficient processor or storage capacity available to use complex compression algorithms such as JPEG, etc. In such cases, a simpler compression algorithm may be used in which a frame buffer or a visual element stored as a bitmap may be transmitted by serializing each horizontal line and creating a description of the pixels in the resulting pixel stream in which pixel color values are specified only where they change and those pixel values are accompanied by a value describing how many adjacent pixels in the stream have the same color. Also, in such embodiments where the actual quantity of colors is limited, color lookup tables may be employed to reduce the number of bytes required to specify each color. The compressed data is then caused to be transmitted by the processor 128 to the head unit 106 by the data transfer portion 933.

The processing of the navigation input data and both the commands and control inputs caused by the navigation application 938 also causes the processor 128 to generate navigation output data. The navigation output data may include numerical values and/or various other indicators of current location, current compass heading, or other current navigational data that is meant to be transmitted back to the head unit 106 in a form other than that of one or more visual elements. It should be noted that such navigation output data may be transmitted to the head unit 106 either in response to the receipt of the commands and/or control inputs, or without such solicitation from the head unit 106 (e.g., as part of regular updating of information at predetermined intervals). Such navigation output data is relayed to the communications handling portion 932 to be assembled to then be relayed to the data transfer portion 933 for transmission back to the head unit 106.

The data transfer portion 923 and the image decompression portion 924 causes the processor 120 of the head unit 106 to receive and decompress, respectively, what was caused to be compressed and transmitted by the loss-less image compression portion 934 and the data transfer portion 933, respectively. Also, the data transfer portion 923 and the communications handling portion 922 receive and disassemble, respectively, the navigation output data caused to be assembled and transmitted by the communications handling portion 932 and the data transfer portion 933, respectively. The navigation and UI integration portion 925 then causes the processor 120 to combine the frame buffer images, the visual elements and/or the navigation output data received from the portable navigation system 104 with visual elements and other data pertaining to entertainment to create a single image for display on the screen 114.

As previously discussed, the manner in which visual elements are combined may be changed in response to sensing an approaching hand of a user via a proximity sensor or other mechanism. The proximity of a human hand may be detected through echolocation with ultrasound, through sensing body heat emissions, or in other ways known to those skilled in the art. Where a proximity sensor is used, that proximity sensor may be incorporated into the head unit 106 (such as the depicted as sensor 926), or it may be incorporated into the portable navigation system 104. The processor 120 is caused to place the combined image in a frame buffer 929 by the user interface application 928, and from the frame buffer 929, the combined image is driven onto the screen 114 in a manner that will be familiar to those skilled in the art of graphics systems.

The navigation and UI integration portion 925 may cause various ones of the buttons and knobs 118a-118s to be assigned as proxies for various physical or virtual controls of the portable navigation device 104, as previously discussed. The navigation and UI integration portion 925 may also cause various visual elements pertaining to navigation to be displayed in different locations or to take on a different appearance from how they would otherwise be displayed on the screen 174, as also previously discussed. The navigation and UI integration portion 925 may also alter various details of these visual elements to give them an appearance that better matches other visual employed by the user interface 112 of the head unit 106. For example, the navigation and UI integration portion 925 may alter one or more of the colors of one or more of the visual elements pertaining to navigation to match or at least approximate a color scheme employed by the user interface 112, such as a color scheme that matches or at least approximates colors employed in the interior of or on the exterior of the vehicle into which the head unit 106 has been installed, or that matches or at least approximates a color scheme selected for the user interface 112 by a user, purveyor or installer of the head unit 106.

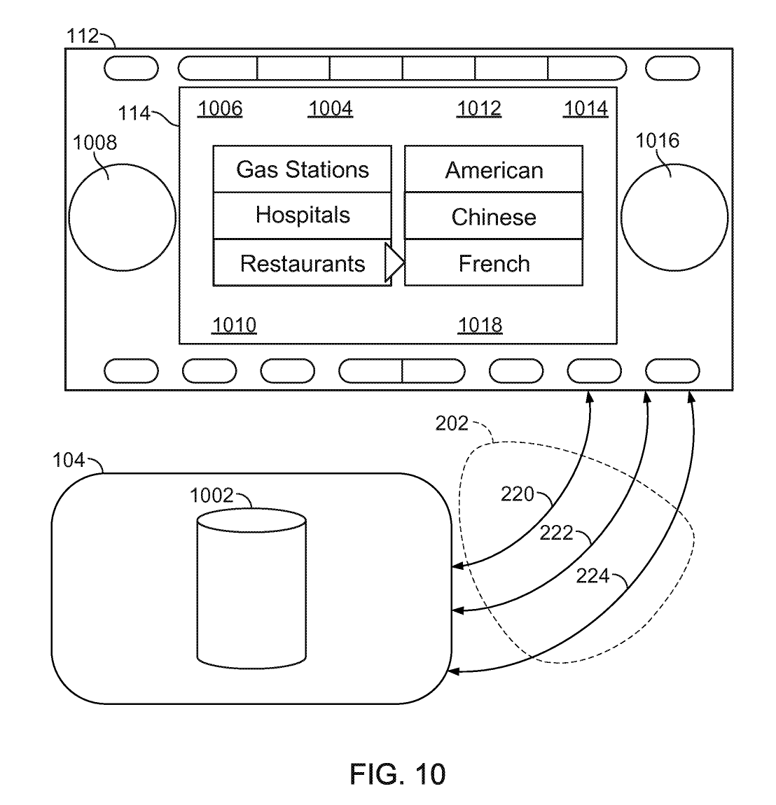

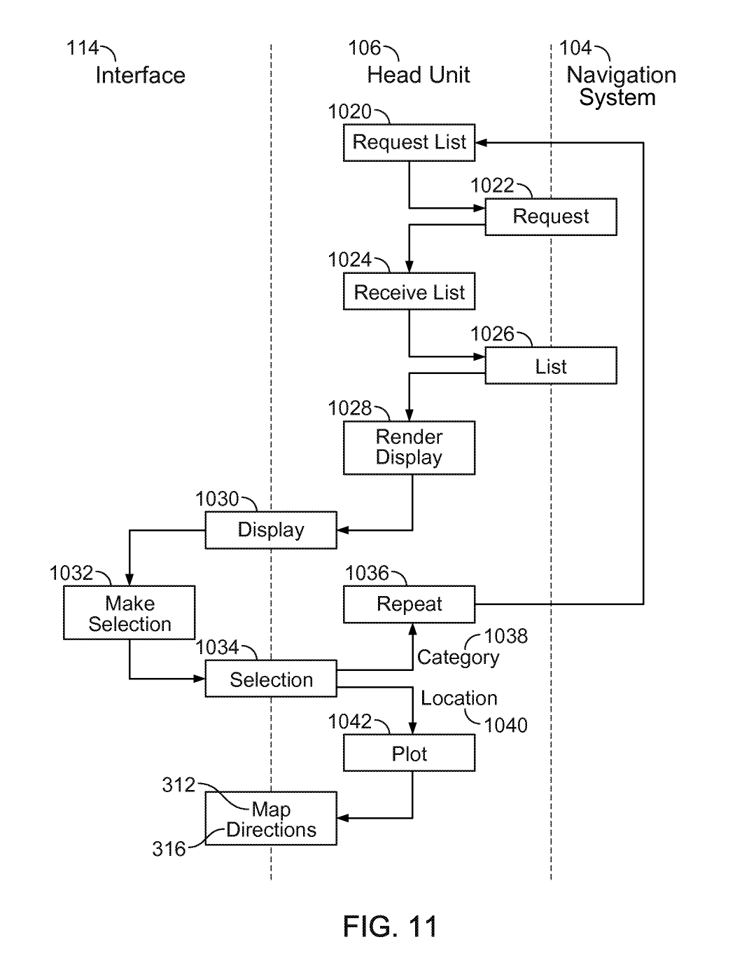

In some examples, the navigation system 104 may be connected to the entertainment system 102 through a direct wire connection as shown in FIG. 7, by a docking unit, as shown in FIGS. 8A and 8B, or wirelessly, as shown in FIG. 9.

In the example of FIG. 7, one or more cables 702, 704, 706, 708 connect the navigation system 104 to the head unit 106 and other components of the entertainment system 102. The cables may connect the navigation system 104 to multiple sources, for example, they may include a direct connection 708 to the external antenna 113 and a data connection 706 to the head unit 106. In some examples, the navigation system 104 may be connected only to the head unit 106, which relays any needed signals from other interfaces such as the antenna 113.

For the features discussed above, the cables 702, 704, and 706 may carry video signals 220, audio signals 222, and commands or information 224 (FIG. 5) between the navigation system 104 and the head unit 106. The video signals 220 may include entire screen images or components, as discussed above. In some examples, dedicated cables, e.g., 702 and 704, are used for video signals 220 and audio signals 222 while a data cable, e.g., 706, is used for commands and information 224. The video connection 702 may be made using video-specific connections such as analog composite or component video or digital video such as DVI or LVDS. The audio connections 704 may be made using analog connections such as mono or stereo, single-ended or differential signals, or digital connections such as PCM, 12S, and coaxial or optical SPDIF. In some examples, the data cable 706 supplies all of the video signals 220, audio signals 222, and commands and information 224. The navigation system 104 may also be connected directly to the vehicle's information and power distribution bus 710 through at least one break-out connection 712. This connection 712 may carry vehicle information such as speed, direction, illumination settings, acceleration and other vehicle dynamics information from other electronics 714, raw or decoded GPS signals if the antenna 113 is connected elsewhere in the vehicle, and power from the vehicle's power supply 716. As noted above, there may be more than one data bus, and an individual device, such as the navigation system 104, may be connected to one or more than one of them, and may receive data signals directly from their sources rather than over one of the busses. Power may be used to operate the navigation system 104 and to charge a battery 720. In some examples, the battery 720 can power the navigation system 104 without any external power connection. A similar connection 718 carries such information and power to the head unit 106.

The data connections 706 and 712 may be a multi-purpose format such as USB, Firewire, UART, RS-232, RS-485, I2C, or an in-vehicle communication network such as controller area network (CAN), or they could be custom connections devised by the maker of the head unit 106, navigation system 104, or vehicle 100. The head unit 106 may serve as a gateway for the multiple data formats and connection types used in a vehicle, so that the navigation system 104 needs to support only one data format and connection type. Physical connections may also include power for the navigation system 104.

As shown in FIG. 8A, a docking 802 unit may be used to make physical connections between the navigation system 104 and the entertainment system 102. The same power, data, signal, and antenna connections 702, 704, 706, and 708 as described above may be made through the docking unit 802 through cable connectors 804 or through a customized connector 806 that allows the various different physical connections that might be needed to be made through a single connector. An advantage of a docking unit 802 is that it may provide a more stable connection for sensitive signals such as from the GPS antenna 113.

The docking unit 802 may also include features 808 for physically connecting to the navigation system 104 and holding it in place. This may function to maintain the data connections 804 or 806, and may also serve to position the navigation system 104 in a given position so that its interface 124 an be easily seen and used by the driver of the car.

In some examples, as shown in FIG. 8B, the docking unit 802 is integrated into the head unit 106, and the navigation system's interface 124 serves as part or all of the head unit's interface 112. (The navigation system 104 is shown removed from the dock 802 in FIG. 8B; the connectors 804 and 806 are shown split into dock-side connectors 804a and 806a and device-side connectors 804b and 806b.) This can eliminate the cables connecting the docking unit 802 to the head unit 106. In the example of FIG. 8B, the antenna 113 is shown with a connection 810 to the head unit 106. If the navigation system's interface 124 is being used as the primary interface, some of the signals described above as being communicated from the head unit 106 to the navigation system 104 are in fact communicated from the navigation system 104 to the head unit 106. For example, if the navigation system's interface 124 is the primary interface for the head unit 106, the connections 804 or 806 may need to communicate control signals from the navigation system 104 to the head unit 106 and may need to communicate video signals from the head unit 106 to the navigation system 104. The navigation system 104 can then be used to select audio sources and perform the other functions carried out by the head unit 106. In some examples, the head unit 106 has a first interface 112 and uses the navigation system 106 as a secondary interface. For example, the head unit 106 may have a simple interface for selecting audio sources and displaying the selection, but it will use the interface 124 of the navigation system 104 to display more detailed information about the selected source, such as the currently playing song, as in FIG. 3A or 3D.

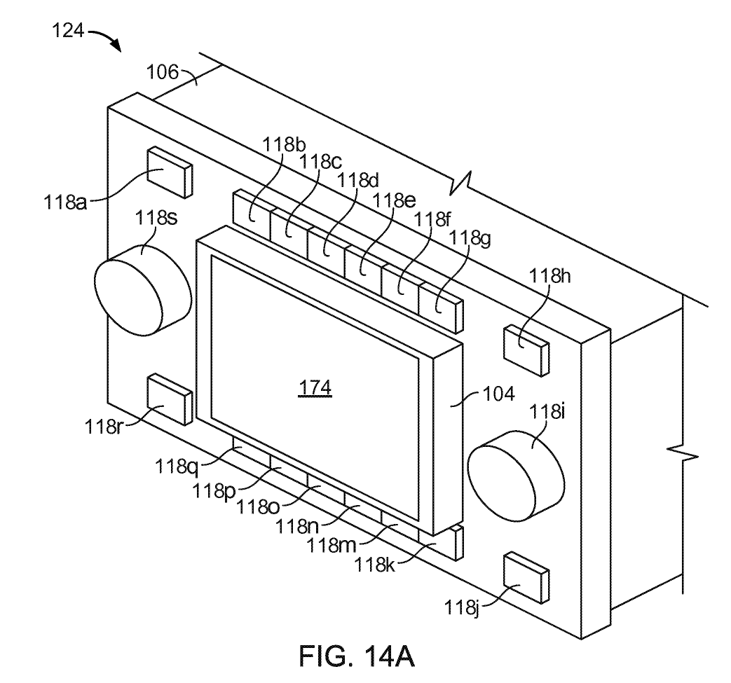

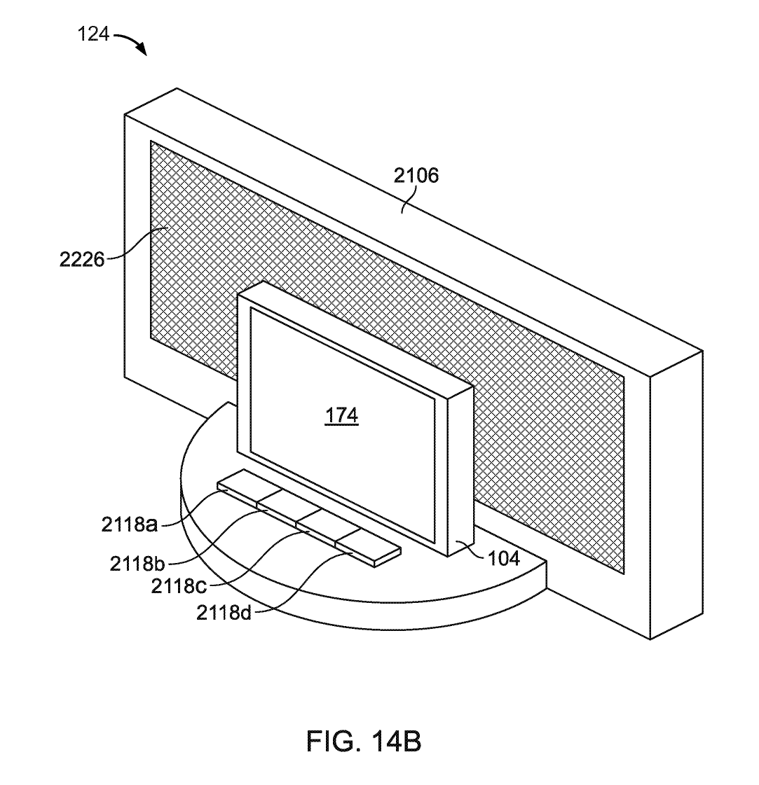

FIG. 14A provides a perspective view of an embodiment of docking between the portable navigation system 104 and the head unit 106 in a manner not unlike what has been discussed with regard to FIG. 8B. As depicted in FIG. 14A, the head unit 106 is meant to receive the portable navigation system 104 at a location in which the portable navigation system 104 is situated among the buttons and knobs 118a-s when docked. Once docked in this position, the screen 174 of the portable navigation system 104 occupies the same space as the screen 114 would occupy in earlier discussed embodiments of the head unit 106, thereby allowing the screen 174 to most easily take the place of the screen 114. With the screen 174 thus positioned, the user interface 124 of the portable navigation system 104 provides much of the same function and may provide much of the same user experience in providing a combined display of navigation and entertainment functionality as did the user interface 112 of earlier discussed embodiments. As previously discussed, some embodiments of the head unit 106 may further provide a screen 114 that may be smaller and/or simpler than the screen 174 that provides part of the user interface 112 to be employed by a user at times when the portable navigation system 104 is not docked with the head unit 106. However, alternate embodiments of the head unit 106 may not provide such a separate screen, thereby relying entirely upon the screen 174 to provide such a visual component in support of user interaction.

FIG. 14B provides a perspective view of an embodiment of a similar docking between the portable navigation system 104 and a base unit 2106 serving as an entertainment system. Not unlike the head unit 106 of FIG. 14A, the base unit 2106 provides multiple buttons 2118a-d, and the docking of the portable navigation system 104 with the base unit 2106 provides the screen 174 as the main visual component of a user interface 124 (alternatively, the screen 174 may become the only such visual component). Also not unlike the head unit 106, the primary function of the base unit 2106 is to supply at least a portion of the hardware and software necessary to create an entertainment system by which audio entertainment may be listened to by playing audio through one or more speakers 2226 provided by the base unit 2106. However, in some embodiments of a simplified form of the base unit 2106, the base unit 2106 may have little in the way of functionality that is independent of being docked with the portable navigation system 104. Such simpler embodiments of the base unit 2106 may rely on the portable navigation system 104 to have the requisite software and entertainment data to control the base unit 2106 to play audio provided by the portable navigation system 104.

Referring now to both FIGS. 14A and 14B, in some embodiments of docking between the portable navigation system 104 and either the head unit 106 or the base unit 2106, the user interface 124 of the portable navigation system 104 automatically adopts a characteristic of a user interface installed in the device to which the portable navigation system is docked. For example, upon being docked to either of head unit 106 or the base unit 2106, the portable navigation system 104 may automatically alter its user interface 124 to adopt a color scheme, text font, shape of virtual button, language selection or other user interface characteristic of either the head unit 106 or the base unit 2106, respectively, thereby providing a user interface experience that is consistent in these ways with the user interface experience that is provided by either head unit 106 or the base unit 2106 when operated independently of the portable navigation system 104. In so doing, the portable navigation system 104 may receive visual elements from either the head unit 106 or the base unit 2106 in a manner similar to previously discussed embodiments of the head unit 106 receiving visual elements from the portable navigation system 104, including the use of loss-less compression.

Furthermore, upon being docked with either the head unit 106 or the base unit 2106, the user interface 124 of the portable navigation system 104 may automatically alter its user interface to make use of one or more of the buttons and knobs 118a-118s or the buttons 2118a-2118d in place of one or more of whatever physical or virtual controls that the user interface 124 may employ on the portable navigation system 104 when the portable navigation system 104 is used separately from either the head unit 106 or the base unit 2106.

Such features of the user interface 124 as adopting user interface characteristics or making use of additional buttons or knobs provided by either the head unit 106 or the base unit 2106 may occur when the portable navigation system 104 becomes connected to either the head unit 106 or the base unit 2106 in other ways than through docking, including through a cable-based or wireless connection (including wireless connections making use of ultrasonic, infrared or radio frequency signals). More specifically, the user interface 124 may automatically adopt characteristics of a user interface of either the head unit 106 or the base unit 2106 upon being brought into close enough proximity to engage in wireless communications with either. Furthermore, such wireless communications may enable the portable navigation system 104 to be used as a form of wireless remote control to allow a user to operate various aspects of either the head unit 106 or the base unit 2106 in a manner not unlike that in which many operate a television or stereo component through a remote control.

Still further, the adoption of user interface characteristics by the user interface 124 may be mode-dependent based on a change in the nature of the connection between the portable navigation system 104 and either of the head unit 106 or the base unit 2106. More specifically, when the portable navigation system 104 is brought into close enough proximity to either the head unit 106 or the base unit 2106, the user interface 124 of the portable navigation system 104 may adopt characteristics of the user interface of either the head unit 106 or the base unit 2106. The portable navigation system 104 may automatically provide either physical or virtual controls to allow a user to operate the portable navigation system 104 as a handheld remote control to control various functions of either the head unit 106 or the base unit 2106. This remote control function would be carried out through any of a variety of wireless connections already discussed, including wireless communications based on radio frequency, infrared or ultrasonic communication. However, as the portable navigation system 104 is brought still closer to either the head unit 106 or the base unit 2106, or when the portable navigation system 104 is connected with either the head unit 106 or the base unit 2106 through docking or a cable-based connection, the user interface 124 may automatically change the manner in which it adopts characteristics of the user interface of either the head unit 106 or the base unit 2106. The portable navigation system 104 may cease to provide either physical or virtual controls and start to function more as a display of either the head unit 106 or the base unit 2106, and may automatically cooperate with the head unit 106 or the base unit 2106 to enable use of the various buttons or knobs on either the head unit 106 or the base unit 2106 as previously discussed with regard to docking.

Upon being docked or provided a cable-based connection to either the head unit 106 or the base unit 2106, the portable navigation system 104 may take on the behavior of being part of either the head unit 106 or the base unit 2106 to the extent that the combination of the portable navigation system 104 and either the head unit 106 or the base unit 2106 responds to commands received from a remote control of either the head unit 106 or the base unit 2106. Furthermore, an additional media device (not shown), including any of a wide variety of possible audio and/or video recording or playback devices, may be in communication with either combination such that commands received by the combination from the remote control are relayed to the additional media device.

Further, upon being docked with the base unit 2106, the behaviors that the portable navigation system 104 may take on as being part of the base unit 2106 may be modal in nature depending on the proximity of a user's hand in a manner not unlike what has been previously discussed with regard to the head unit 106. By way of example, the screen 174 of the portable navigation system 104 may display visual artwork pertaining to an audio recording (e.g., cover art of a music album) until a proximity sensor (not shown) of the base unit 2106 detects the approach of a user's hand towards the base unit 2106. Upon detecting the approach of the hand, the screen 174 of the portable navigation system 104 may automatically switch from displaying the visual artwork to displaying other information pertaining to entertainment. This automatic switching of images may be caused to occur on the presumption that the user is extending a hand to operate one or more controls. The user may also be provided with the ability to turn off this automatic switching of images. Not unlike the earlier discussion of the use of a proximity sensor with the head unit 106, a proximity sensor employed in the combination of the personal navigation system 104 and the base unit 2106 may be located either within the personal navigation system 104 or the base unit 2106.

In either the case of a combination of the personal navigation system 104 with the head unit 106 or a combination of the personal navigation system 104 with the base unit 2106, a proximity sensor incorporated into the personal navigation system 104 may be caused through software stored within the personal navigation system 104 to be assignable to being controlled and/or monitored by either the head unit 106 or the base unit 2106 for any of a variety of purposes.

In some embodiments of interaction between the portable navigation system 104 and either the head unit 106 or the base unit 2106, the portable navigation system 104 may be provided the ability to receive and store new data from either the head unit 106 or the base unit 2106. This may allow the portable navigation system 104 to benefit from a connection that either the head unit 106 or the base unit 2106 may have to the Internet or to other sources of data that the portable navigation system 104 may not itself have. In other words, upon there being a connection formed between the portable navigation system 104 and either the head unit 106 or the base unit 2106 (whether that connection be wired, wireless, through docking, etc.), the portable navigation system 104 may be provided with access to updated maps or other data about a location, or may be provided with access to a collection of entertainment data (e.g., a library of MP3 files).

In some embodiments of interaction between the portable navigation system 104 and either the head unit 106 or the base unit 2106, software on one or more of these devices may perform a check of the other device to determine if the other device or the software of the other device meets one or more requirements before allowing some or all of the various described forms of interaction to take place. For example, copyright considerations, electrical compatibility, nuances of feature interactions or other considerations may make it desirable for software stored within the portable navigation system 104 to refuse to interact with one or more particular forms of either a head unit 106 or a base unit 2106, or to at least limit the degree of interaction in some way. Similarly, it may be desirable for software stored within either the head unit 106 or the base unit 2106 to refuse to interact with one or more particular forms of a portable navigation system 104, or to at least limit the degree of interaction in some way. Furthermore, it may be desirable for any one the portable navigation system 104, the head unit 106 or the base unit 2106 to refuse to interact with or to at least limit interaction with some other form of device that might otherwise have been capable of at least some particular interaction were it not for such an imposed refusal or limitation. Where interaction is simply limited, the interaction may be a limit against the use of a given communications protocol, a limit against the transfer of a given piece or type of data, a limit to a predefined lower bandwidth than is otherwise possible, or some other limit.

In some examples, a wireless connection 902 can be used to connect the navigation system 104 and the entertainment system 102, as shown in FIG. 9. Standard wireless data connections may be used, such as Bluetooth, WiFi, or WiMax, as noted above. Proprietary connections could also be used. Each of the data signals 202 (FIG. 5) can be transmitted wirelessly, allowing the navigation system 104 to be located anywhere in the car and to make its connections to the entertainment system automatically. This may, for example, allow the user to leave the navigation system 104 in her purse or briefcase, or simply drop it on the seat or in the glove box, without having to make any physical connections. In some example, the navigation system is powered by the battery 720, but a power connection 712 may still be provided to charge the battery 720 or power the system 104 if the battery 720 is depleted.

The wireless connection 902 may be provided by a transponder within the head unit 106 or another component of the entertainment system 102, or it may be a stand-alone device connected to the other entertainment system components through a wired connection, such as through the data bus 710. In some examples, the head unit 106 includes a Bluetooth connection for connecting to a user's mobile telephone 906 and allowing hands-free calling over the audio system. Such a Bluetooth connection can be used to also connect the navigation system 106, if the software 122 in the head unit 106 is configured to make such connections. In some examples, to allow a wirelessly-connected navigation system 104 to use the vehicle's antenna 113 for improved GPS reception, the antenna 113 is connected to the head unit 106 with a wired connection 810, and GPS signals are interpreted in the head unit and computed longitude and latitude values are transmitted to the navigation system 104 using the wireless connection 902. In the example of Bluetooth wireless technology, a number of Bluetooth profiles may be used to exchange information, including, for example, advanced audio distribution profile (A2DP) to supply audio information, video distribution profile (VDP) for screen images, hands-free, human interface device (HID), and audio/video remote control (AVRCP) profiles for control information, and serial port and object push profiles for exchanging navigation data, map graphics, and other signals.

In some examples, as shown in FIGS. 10 and 11, the navigation system 104 may include a database 1002 of points of interest and other information relevant to navigation, and the user interface 112 of the head unit 106 may be used to interact with this database. For example, if a user wants to find all the Chinese restaurants near his current location, he uses the controls 118 on the head unit 106 to move through a menu 1004 of categories such as “gas stations” 1006, “hospitals” 1008, and “restaurants” 1010, selecting “restaurants” 1010. He then uses the controls 118 to select a type of restaurant, in this case, “Chinese” 1016, from a list 1012 of “American” 1014, “Chinese” 1016, and “French” 1018. Examples of a user interface for such a database are described in U.S. patent application Ser. No. 11/317,558, filed Dec. 22, 2005, which is incorporated here by reference.

This feature may be implemented using the process shown in FIG. 11. The head unit 106 queries the navigation system 104 by requesting 1020 a list of categories. This request 1022 may include requesting the categories, an index number and name for each, and the number of entries in each category. Upon receiving 1024 the requested list 1026, the head unit 106 renders 1028 a graphical display element and displays it 1030 on the display 114. This display may be generated using elements in the head unit's memory or may be provided by the navigation system 104 to the head unit 106 as described above. Once the user makes 1032 a selection 1034, the head unit either repeats 1036 the process of requesting 1020 a list 1026 for selected category 1038 or, if the user has selected a list item representing a location 1040, the head unit 106 plots 1042 that location 1040 on the map 312 and displays directions 316 to that location 1040. Similar processes may be used to allow the user to add, edit, and delete records in the database 1002 through the interfaced 112 of the head unit 106. Other interactions that the user may be able to have with the database 1002 include requesting data about a point of interest, such as the distance to it, requesting a list of available categories, requesting a list of available locations, or looking up an address based on the user's knowledge of some part of it, such as the house number, street name, city, zip code, state, or telephone number. The user may also be able to enter a specific address.

Other implementations are within the scope of the following claims and other claims to which the applicant may be entitled. Elements of different implementations described herein may be combined to form different implementations not specifically described.

What is claimed is:

1. A method of providing an external interface to a portable device that has its own native interface, the native interface of the portable device presenting options of a first level of a hierarchy, and upon selection of a first one of the options, replacing the display of options with a new display of a first set of options from a second level of the hierarchy, the first set of options from the second level corresponding to the first option from the first level, the method comprising:
displaying on the external interface at least a subset of the options of the first level of the hierarchy, the subset including the first option and at least one second option,
indicating in the display that the first option is selected, and
simultaneously displaying the first set of options from the second level of the hierarchy.

2. The method of claim 1, further comprising:
in response to a first user input, indicating in the display that the first option is no longer selected,
indicating that the second option is now selected, and
simultaneously replacing the displayed options from the first set of options from the second level with a second set of options from the second level, the second set of options corresponding to the second option from the first level.

3. The method of claim 2, further comprising:
when displaying either the first set of options or the second set of options from the second level of the hierarchy,
in response to a second user input, indicating in the display that one of the options of the displayed set from the second level of the hierarchy is selected.

4. The method of claim 3, wherein the second user input is preceded by a third user input different from the first or second user input, and the second user input is received from the same input mechanism as the first user input.

5. The method of claim 3, wherein the second user input is received from a different input mechanism than the first user input.

6. The method of claim 3, further comprising:
in response to a second user input, replacing the content of the external display with a duplicate of the native user interface of the portable device.

7. In a display on a first device of options applicable to a remote device connected to the first device, displaying the options using images provided by the remote device.

8. The method of claim 7, further comprising modifying the color of the images provided by the remote device to conform to a color scheme of the first device.

9. The method of claim 7, further comprising modifying the resolution of the images provided by the remote device to conform to a resolution of the first device.

10. A method of providing a user interface on a first device for controlling a second device, the method comprising:
storing, in the first device, a set of graphical tiles, including an organized set of references to the tiles;
receiving, from the second device, references corresponding to the organized set of references, and instructions for organizing a display of tiles corresponding to the references;
retrieving, from the storage, graphical tiles corresponding to the identifications received from the second device;
displaying, on the first device, the graphical tiles retrieved from the storage, organized on the display according to the received instructions.
